(19) United States
(12) Patent Application Publication
(10) Pub. No.: US 2026/0209920 A1
(43) Pub. Date: Jul. 23, 2026

(54) NOVEL IRON-CHROMIUM BASED ALLOYS FOR LASER CLADDING

(71) Applicant: HÖGANÄS AB (Publ), Höganäs (SE)

(72) Inventors: Robert FRYKHOLM, Ödåkra (SE); Arashk MEMARPOUR, Helsingborg (SE); Barbara MAROLI, Höganäs (SE)

(73) Assignee: HÖGANÄS AB (Publ), Höganäs (SE)

(21) Appl. No.: 19/138,493

(22) PCT Filed: Dec. 18, 2023
(86) PCT No.: PCT/EP2023/086402

§ 371 Date: Jun. 12, 2025

(30) Foreign Application Priority Data
Dec. 20, 2022 (EP) 22215098.9
Mar. 21, 2023 (EP) 23163164.9

(51) Int. Cl. C22C 38/54; B22F 1/05; B22F 9/08; C22C 38/02; C22C 38/04; C22C 38/44; C23C 24/10

(52) U.S. Cl. CPC C22C 38/54; B22F 1/05; B22F 9/08; C22C 38/02; C22C 38/04; C22C 38/44; C23C 24/106; B22F 2301/35; B22F 2304/10

(57) ABSTRACT

For providing laser cladded surfaces with low cracking risk in the laser cladded surface, whether macro or micro cracking, an iron-chromium based alloy is provided, consisting of by weight of total weight of alloy:

| | | |
|---|---|---|
| Chromium (Cr) | : | 20.5 wt %-28.0 wt %, |
| Nickel (Ni) | : | up to 5.0 wt %, |
| Silicon (Si) | : | 0.5 wt %-2.5 wt %, |
| Boron (B) | : | 0.50 wt %-1.5 wt %, |
| Molybdenum (Mo) | : | 0.15 wt %-2.0 wt %, |
| Manganese (Mn) | : | 0.10 wt %-0.90 wt %, |
| Carbon (C) | : | 0.01 wt %-0.20 wt %, |
| Niobium (Nb) | : | up to 1.5 wt %, |
| Copper (Cu) | : | up to 0.2 wt %, |
| Cobalt (Co) | : | up to 1.0 wt %, |

the balance being iron (Fe) and unavoidable impurities not exceeding 0.3 wt %.

### TECHNICAL FIELD

Within the field of iron-chromium based alloys there are disclosed a range of novel iron-chromium based alloys which are suitable for laser cladding with minimal crack formation during the laser cladding process.

### BACKGROUND

In recent years, laser cladding to a large extent has replaced hard chromium plating of wear parts exposed to saline environments, such as e.g., in the mining industry for piston rods for hydraulic roof supports, as such laser cladded wear parts may have their lifetime increased by up to five times using laser cladding over the previous hard chromium plating. E.g., laser cladding using Rockit® 401 (Fe-18Cr-2.5Ni-0.5Mo-0.15C) from Höganäs AB has been used in the coal mining industry during the last ten years to coat piston rods for hydraulic roof supports, becoming the current market leading alloy for laser cladding, both globally and particularly in the APAC-region.

At present only large piston rods, most parts having a diameter of 300 mm and a length of 1300 mm, are laser cladded. This represents roughly 15-20% of produced piston rods, including new products and refurbishment. The remaining 85% are hard chromium plated due to cost and technical issues with laser cladding wear parts. E.g., piston rods currently in use typically have diameters too small for adequately dissipating the high heat input under current production conditions for current laser cladding processes. Nevertheless, due to the benefits to lifetime etc., the future goal for the OEMs is to laser clad 100% of the produced wear parts, including piston rods, without the current size limitations.

Also, there is a pull from OEMs to reduce the coating costs by increasing productivity e.g., by using higher clad speeds and new types of nozzles, reducing the coating thicknesses, and/or minimizing post welding processes e.g., machining. Currently, industrial standard coating thicknesses after deposition are on the order of 1.2 mm, but the industry goal is to decrease this to below 0.8 mm, preferably to below 0.5 mm or even below 0.3 mm. These further requirements pose new demands on the alloys and the powder particle sizes used in the laser cladding processes, as higher clad speeds and lower coating thicknesses result in higher cooling rates of the coating material, and potentially higher internal stresses, and further influences the alloy welding behavior, the final coating microstructure etc.

For increasing the cladding speed while at the same time reducing the coating thickness, it is necessary to use smaller coating particles during the laser cladding process compared to processes where thicker coatings desired, as smaller particles melt faster. In the art, a working range for the particle size distribution for laser cladding can be from 10 μm to 150 μm, however high-speed laser cladding requires particle size distributions which are more narrowly defined, and current industry target distributions range aim at finding the particle size distributions in the range of from 10 μm to 110 μm.

Unfortunately, existing iron-chromium alloys falling in the desired size distribution range, were found unsatisfactory in test experiments performed by the present inventors, when attempting to produce thinner coatings than currently marketed, as the increased cooling rate associated with thinner coatings was found to lead to crack formation and an unstable microstructure. Additionally, the resulting hardness of the coating layer, when thin-coat cladding using existing iron-chromium powders on the market, show unsatisfactory scatter in hardness/wear resistance and corrosion of such coatings based on existing iron-chromium powders.

The present invention therefore is motivated by this current need for new robust alloys suitable for high speed/high productivity laser cladding processes, which can be used to produce thin (<0.3 mm) and essentially crack free coatings having a stable microstructure and hardness in the range of 400-550 Vickers, while having the same corrosion resistance and machinability as the best protective iron-chromium alloys for laser cladding currently on the market, such as e.g., Rockit® 401.

In the field of the present invention, alloy powders for laser cladding repair of a mining hydraulic stand column are known e.g., from CN113046625, the alloy comprising 15-17 wt % Cr, 1.5-2.0 wt % Ni, 1.5-2.0 wt % Co, 0.8-1.2 wt % Mo, 0.0-0.4 wt % Mn, 0.1-0.2 wt % Nb, 0.07-0.14 wt % C, 0.06-0.12 wt % N, 0.03-0.06 wt % Ce, 0.6-1.0 wt % B, 0.8-1.2 wt % Si, with the balance being Fe.

However, the high content of cobalt results in health and safety issues for operators using the alloy powders of the prior art, thus requiring special precautions during manufacture. Consequently, avoiding cobalt above a level of unintentional inclusions is a further aim of the present disclosure, which is solved by the herein detailed iron-chromium alloys.

In CN111097908 there is detailed the use of alloyed particles for laser cladding done using particle sizes of from 15 μm to 53 μm @ 50 m/min for obtaining a 1.5 mm cladding layer, the alloys consisting of Cr 17.5-19.5 wt %, Ni 1.7-2.3 wt %, Si 0.8-1.2 wt %, B 0.9-1.2 wt %, Mo 0.4-0.6 wt %, Mn≤0.3 wt %, C 0.15-0.23 wt %, iron (Fe) being balance. The resulting surface hardness (HV) was 658 HV.

In CN111809177 there is detailed the use of alloyed particles for laser cladding done using particle sizes of from 15 μm to 175 μm for obtaining a 1.4 mm cladding layer, the alloys consisting of Cr 18-19 wt %, Ni 3.6-4 wt %, Si 1.1-1.3 wt %, B 0.9-1.1 wt %, Mo 1.5-1.7 wt %, Mn 0.2-0.3 wt %, C 0.15-0.20 wt %, Nb 0.5-0.55 wt %, Co 0.1-0.15 wt %, V 0.1-0.15 wt %, iron (Fe) being balance and having 0.06-0.08 wt % inclusion of nitrogen from the atomization of the alloy melt used to form the alloyed particles used. The resulting surface hardness (HV) was 700 HV.

According to the inventors in the latter two prior art documents, CN111097908 and CN111809177, the resulting coatings are highly resistant to corrosion at the chosen level of the iron-chromium balance, thereby corroborating the present applicant's own findings with respect to their marketed product Rockit® 401, which has the same chromium content as both later disclosures. Also, the observed hardness levels of the prior art match the present applicant's marketed product, Rockit® 401.

A problem with the alloys suggested in the latter two references is that a very thick coating must be produced for avoiding crack formation in the deposited coating layer, when using high speed laser cladding for coating, as the high hardness of the prior art coatings make them highly susceptible to releasing internal hardness stresses by cracking, which is therefore compensated by increasing the layer thickness. A similar problem was observed for the present applicant's own product Rockit® 401 (Fe-18Cr-2.5Ni-0.5Mo-0.15C).

This observation forms the onset of the present inventors' search for cobalt free iron-chromium based alloys which do not suffer from the same drawbacks with respect to crack-formation during laser cladding, a crack-formation which must be compensated for with increasing the cladding thickness, thereby using more material and increasing the coating cost.

Surprisingly, the present inventors' have found that the abovementioned drawbacks can be alleviated in a simple manner as herein detailed by increasing the chromium content over that known from the prior art, where in a restricted region of increased chromium content, a favorable bcc/fcc-balance of the resulting alloys is formed, which maintains the corrosion resistance known from the prior art, but surprisingly permits high-speed laser cladding without crack-formation in coating layers of thicknesses of from about 100 μm to about 350 μm, correlated with a lowering of the hardness of the coated layers to about HV 400-450, which remains fully acceptable for the suggested uses.

This outcome is unexpected since prior art indicates that chromium increases hardness and therefore the susceptibility to stress cracking as observed in the coatings of the prior art even for lower chromium concentrations.

### SUMMARY OF THE INVENTION

In accordance with the present disclosure and invention, the objectives of the present disclosure are solved by providing in a first aspect and embodiment thereof an iron-chromium based alloy consisting of by weight of total weight of alloy:

| | | |
|---|---|---|
| Chromium (Cr) | : | 20.5 wt %-28.0 wt %, |
| Nickel (Ni) | : | up to 5.0 wt %, |
| Silicon (Si) | : | 0.5 wt %-2.5 wt %, |
| Boron (B) | : | 0.50 wt %-1.5 wt %, |
| Molybdenum (Mo) | : | 0.15 wt %-2.0 wt %, |
| Manganese (Mn) | : | 0.10 wt %-0.90 wt %, |
| Carbon (C) | : | 0.01 wt %-0.20 wt %, |
| Niobium (Nb) | : | up to 1.5 wt %, |
| Copper (Cu) | : | up to 0.2 wt %, |
| Cobalt (Co) | : | up to 1.0 wt %, |

the balance being iron (Fe) and unavoidable impurities not exceeding 0.3 wt %.

Further aspects and embodiments are herein detailed in the description and in the claims.

### BRIEF DESCRIPTION OF THE DRAWINGS

FIG. 1: Hardness HV0.2 for alloys A1-A8, A10-A12, A20-A24.

FIG. 2: Hardness of alloys A1-A8 and A10-A12 plotted vs calculated volume fractions of borides and austenite.

FIG. 3: Hardness of alloys A26-A34 containing Nb between 0.5-1.0 wt %.

FIG. 4: Qualitative estimation of the number of microcracks in coatings of alloys A1 to A12, A16, A17 and A20-A24.

FIG. 5: Qualitative estimation of the number of microcracks vs. melting range calculated using Shiel simulations for the last 10% of melt.

FIG. 6: Influence of boron content on the number of hot cracks in the coating (qualitative estimation).

FIG. 7: Examples of coatings cladded using the HighNo 4.0 nozzle at 30 m/min with A) Alloy A3 limited number of defects as pores and microcracks and B) Alloy A5 large number of defects.

FIG. 8: Examples of coatings cladded using the HighNo 4.0 nozzle at 100 m/min with A) Alloy A3 limited number of defects as pores and microcracks and B) Alloy A5 large number of defects.

FIG. 9: Examples of microstructure for coatings with alloys A10 and A7, cladded respectively at 30 m/min and 100 m/min using an HighNo 4.0 nozzle.

FIG. 10: Microstructure of coatings for A10 in higher magnification coated at A) 30 m/min and B) 100 m/min.

FIG. 11: Alloy A1, A) LOM-overview, B) SEM EBSD map, and C) Euler map.

FIG. 12: Alloy A7, A) LOM-overview, B) SEM EBSD map, and C) Euler map.

FIG. 13: Alloy A10, A) LOM-overview, B) SEM EBSD map, and C) Euler map.

FIG. 14: Exemplary samples rated for degree of corrosion after 7 days in NSS chamber.

FIG. 15: Boron corrosion ranking after 7 days in NSS.

FIG. 16: Chromium corrosion ranking after 7 days in NSS.

FIG. 17: ThermoCalc-results for 3 different Cr-concentrations.

### DETAILED DESCRIPTION

In accordance with the present disclosure and invention, the objectives of the present disclosure are solved by providing in a first aspect and embodiment thereof an iron-chromium based alloy consisting of by weight of total weight of alloy:

| | | |
|---|---|---|
| Chromium (Cr) | : | 20.5 wt %-28.0 wt %, |
| Nickel (Ni) | : | up to 5.0 wt %, |
| Silicon (Si) | : | 0.5 wt %-2.5 wt %, |
| Boron (B) | : | 0.50 wt %-1.5 wt %, |
| Molybdenum (Mo) | : | 0.15 wt %-2.0 wt %, |
| Manganese (Mn) | : | 0.10 wt %-0.90 wt %, |
| Carbon (C) | : | 0.01 wt %-0.20 wt %, |
| Niobium (Nb) | : | up to 1.5 wt %, |
| Copper (Cu) | : | up to 0.2 wt %, |
| Cobalt (Co) | : | up to 1.0 wt %, |

the balance being iron (Fe) and unavoidable impurities not exceeding 0.3 wt %.

Surprisingly it was found by the present inventors that laser cladded coatings based on the presently disclosed alloys could be produced on laboratory scale having thicknesses between 100 to 350 μm using clad speeds between 30 and 100 m/min and deposition rates between 0.5 to 1.5 m²/h. The coatings of the present alloys as produced were free from cold cracks and showed a hardness between 400-450 HV; and a corrosion resistance in NSS>>96 h.

Chromium (Cr) with iron form the bulk part of the present alloys, with chromium being the main responsible component for the corrosion protection, with other elements disclosed herein contributing primarily to the properties of powders of the present alloys for use in laser cladding. Advantageously, the working range for chromium when adjusted with other elements in accordance with the present disclosure is rather broad, from 20.5 wt % to 28.0 wt % of chromium in the alloys. However, optimum performance for chromium was found between 23 wt % to 24 wt % of chromium with performance increasing from the aforementioned limits towards this observed optimal concentration interval. Accordingly, in embodiments of the present alloys, there is herein detailed an iron-chromium based alloy, wherein chromium (Cr) is present from 21 wt % to 27 wt %, from 21.5 wt % to 26 wt %, from 22 wt % to 25 wt %, from 22.5 wt % to 24.5 wt %, preferably from 23 wt % to 24 wt %, more preferably from 23.2 wt % to 23.8 wt % or from 23.4 wt % to 23.6 wt %.

Nickel (Ni), alongside chromium, was found useful in corrosion prevention when preparing laser cladded surfaces using the present alloys. However, when the nickel concentration was raised above 5 wt %, the desired surface hardness would suffer, limiting the nickel content upwards thereby. But since nickel, compared to chromium, is an expensive additive, it is accordingly desirable to keep the nickel content as low as possible. In experiments it was found that nickel could be absent or present only to a level of an unavoidable impurity, while still achieving the objects of the present disclosure, however optimal results were found when nickel was present from 1 wt % and up. In embodiments of the present alloys therefore, there is herein detailed an iron-chromium based alloy, wherein nickel (Ni) is present up to 5 wt %, from 0.5 wt % to 5 wt %, from 1 wt % to 5 wt %, from 1.5 wt % to 4.5 wt %, from 2.0 wt % to 4.0 wt %, from 2.15 wt % to 3.85 wt %, from 2.25 wt % to 3.75 wt %, from 2.35 wt % to 3.65 wt %, from 2.50 wt % to 3.50 wt %, from 2.65 wt % to 3.35 wt %, or preferably from 2.75 wt % to 3.25 wt %.

In the experiments it was further found that the main impurity present in the atomized alloys was oxygen (O) due to the high content of chromium, when working from starting materials otherwise low in residual contaminants. Generally, it was found that oxygen as the major unavoidable impurity would be introduced during atomization, particularly during water atomization, the concentration of oxygen in the laboratory experiments did not exceed 0.3 wt % based on the total mass of the alloys, but in initial experiments under production conditions, oxygen was found up to 0.6 wt % based on the total mass of the atomized alloys. Accordingly, in embodiments of the present invention, oxygen (O) as an unavoidable impurity in the atomized alloys can be present up to 0.6 wt %, but preferably is present to a lower extent, such as preferably up to 0.55 wt %, up to 0.5 wt %, up to 0.45 wt %, up to 0.4 wt %, up to 0.35 wt %, or more preferably up to 0.3 wt % or lower.

In embodiments of the present disclosure, copper (Cu) can be present in the alloys of the present disclosure. As the presence of copper in the present alloys was found in general to be detrimental to the avoidance of crack formation during laser cladding, copper cannot be present in amounts exceeding 0.2 wt % Cu. Accordingly in embodiments of the present disclosure there is herein detailed, an iron-chromium based alloy, wherein copper (Cu) is present up to 0.2 wt %, up to 0.15 wt %, or wherein copper (Cu) is present up to 0.1 wt %, or 0.05 wt %, but preferably wherein copper is present only as an unavoidable impurity, preferably below detection level.

In the experiments, it was found possible to use up to 1.0 wt % cobalt (Co) as an uninfluencing filler into the present alloys. However, for health and safety reasons in laser cladding processes and when handling iron-powders containing cobalt, the present alloys preferably do not rely on cobalt for their properties. In preferred embodiments of the present alloys therefore, there is herein detailed an iron-chromium based alloy, wherein cobalt (Co) can be present up to 0.2 wt %, preferably can be present up to 0.1 wt %, but preferably cobalt, if present, is present only as an unavoidable impurity, preferably below detection level.

In the experiments it was found that niobium (Nb) beneficially reduces crack formation during laser cladding whenever present, and that for high concentrations of boron (B) and/or carbon (C), niobium is a necessary additive for crack-prevention during laser cladding. And while niobium consequently may be absent from the present alloys, or only present as an unavoidable impurity, in embodiments of the present alloys, there is herein detailed an iron-chromium based alloy, wherein niobium (Nb) is present from 0.30 wt %, from 0.35 wt %, from 0.40 wt %, from 0.45 wt %, from 0.5 wt %, from 0.55 wt %, from 0.60 wt %, from 0.70 wt %, from 0.8 wt %, from 0.9 wt %, or from 1.0 wt %, to 1.4 wt %, to 1.3 wt %, to 1.2 wt %, to 1.1 wt %, to 1.0 wt %, to 0.9 wt %, or to 0.8 wt %, preferably from 0.40 to 1.2 wt %, from 0.45 wt % to 1.1 wt % or from 0.50 wt % to 1.0 wt %.

In an embodiment thereof, there is herein detailed an iron-chromium based alloy, wherein if one of either the content of carbon (C) exceeds 0.15 wt %, the content of boron (B) exceeds 1.1 wt %, or the combined content of carbon and boron exceeds 1.20 wt %, niobium (Nb) is present from 0.30 wt % to 1.5 wt %, preferably from 0.5 wt % to 1.25 wt %, more preferably from 0.6 wt % to 1 wt %.

The elements silicon (Si), boron (B), molybdenum (Mo), manganese (Mn), and carbon (C) are mandatorily present in the alloys of the present disclosure, their presence having been found necessary for providing the necessary adjustment to the laser cladding or corrosion resistance properties of iron, chromium and, if present, nickel. From the experiments, certain optimal concentrations for the abovementioned elements could be derived, as detailed herein below.

It was found that silicon (Si) necessarily shall be present from 0.5 wt % to 2.5 wt % in the alloys of the present disclosure. However, in embodiments of the present alloys, there is herein detailed iron-chromium based alloys, wherein silicon (Si) is present from 0.75 wt % to 2.45 wt %, from 1.0 wt % to 2.4 wt %, from 1.25 wt % to 2.35 wt %, preferably from 1.4 wt % to 2.3 wt %, from 1.5 wt % to 2.3 wt %, from 1.6 wt % to 2.3 wt %, more preferably from 1.7 wt % to 2.3 wt %, from 1.8 wt % to 2.2 wt %, or more preferably from 1.9 wt % to 2.1 wt %. It was found that when the amount of silicon exceeds 1.4 wt %, crack formation is minimized.

It was found that boron (B) necessarily shall be present from 0.5 wt % to 1.5 wt % in the alloys of the present disclosure. However, in embodiments of the present alloys, there is herein detailed an iron-chromium based alloy, wherein boron (B) is present from 0.6 to 1.4 wt %, from 0.7 wt % to 1.3 wt %, from 0.8 wt % to 1.2 wt %, from 0.9 wt % to 1.1 wt %, or preferably from 0.95 wt % to 1.05 wt %.

It was found that molybdenum (Mo) necessarily shall be present from 0.15 wt % to 2.0 wt % in the alloys of the present disclosure. However, in embodiments of the present alloys, there is herein detailed an iron-chromium based alloy, wherein molybdenum (Mo) is present up to 1.9 wt %, up to 1.8 wt %, up to 1.7 wt %, up to 1.6 wt %, up to 1.5 wt %, preferably up to 1.4 wt %, up to 1.3 wt %, up to 1.2 wt %, up to 1.1 wt %, up to 1.0 wt %, up to 0.90 wt %, up to 0.80 wt %, more preferably up to 0.70 wt %, up to 0.60 wt %, up, or more preferably up to 0.50 wt %.

In an embodiment thereof, there is herein detailed an iron-chromium based alloy, wherein molybdenum (Mo) is present from 0.20 wt %, from 0.25 wt %, from 0.30 wt %, from 0.35 wt %, from 0.40 wt %, from 0.45 wt %, from 0.50 wt %, from 0.55 wt %, from 0.60 wt %, from 0.65 wt % or from 0.70 wt %.

In an embodiment thereof, there is herein detailed an iron-chromium based alloy, wherein molybdenum (Mo) is present from 0.20 wt % to 1.3 wt %, from 0.25 wt % to 1.1 wt %, from 0.3 wt % to 0.90 wt %, from 0.35 wt % to 0.70 wt %, or from 0.40 wt % to 0.60 wt %.

In further embodiments thereof, there is herein detailed an iron-chromium based alloy, wherein molybdenum (Mo) is present from 0.3 wt % to 1.8 wt %, or from 0.4 wt % to 1.7 wt %, preferably from 0.5 wt % to 1.6 wt %, or from 0.6 wt % to 1.5 wt %, more preferably between 0.6 wt % and 1.5 wt %, or from 0.65 wt % to 1.45 wt %, most preferably from 0.7 wt % to 1.4 wt %, from 0.75 wt % to 1.35 wt %, or from 0.8 wt % to 1.3 wt %.

It was found that manganese (Mn) necessarily shall be present from 0.1 wt % to 0.9 wt % in the alloys of the present disclosure. However, in embodiments of the present alloys, there is herein detailed an iron-chromium based alloy, wherein manganese (Mn) is present from 0.2 wt %, or from 0.3 wt %, preferably from 0.35 wt %, or from 0.40 wt %, or more preferably from 0.45 wt %, or from 0.50 wt %; and to 0.85 wt %, to 0.80 wt %, to 0.75 wt %, to 0.70 wt %, to 0.65 wt %, to 0.60 wt %, to 0.55 wt % or to 0.50 wt %. In embodiments thereof, manganese (Mn) preferably is present from 0.30 wt % to 0.80 wt %, from 0.35 wt % to 0.7 wt %, or from 0.40 wt % to 0.60 wt %.

Surprisingly, the present inventors have found, when the total concentration of molybdenum (Mo) and manganese (Mn) are in the range from 0.6 to 1.8 wt %, preferably from 0.7 to 1.5 wt %, more preferably from 0.8 to 1.3 wt %, or most preferably from 0.9 to 1.1 wt %, the present alloys have optimal properties.

It was found that the presence of carbon (C) in the alloys of the present disclosure is necessary for obtaining appropriate hardness of the laser cladded coatings in combination with boron as herein detailed. However, carbon being a light element was observed to reach effective molecular amounts already at concentrations by weight which otherwise in the current context is at the level of unavoidable impurities of carbon contained in the raw materials. For optimal results, however, carbon shall be present from 0.01 wt % to 0.20 wt % in the alloys of the present disclosure, preferably carbon (C) is present from 0.02 wt %, from 0.03 wt %, from 0.04 wt %, from 0.05 wt %, from 0.06 wt %, from 0.07 wt %, from 0.08 wt %, from 0.09 wt %, from 0.10 wt %; and to 0.19 wt %, to 0.18 wt %, to 0.17 wt %, to 0.15 wt %, to 0.14 wt %, to 0.13 wt %, to 0.12 wt %, to 0.11 wt % or to 0.10 wt %, preferably from 0.05 wt % to below 0.15 wt %.

In a preferred embodiment of the present alloys, there is herein disclosed an iron-chromium based alloy consisting of by weight of total weight of alloy:

| | | |
|---|---|---|
| Chromium (Cr) | : | 20.5 wt %-28.0 wt %, |
| Nickel (Ni) | : | 2.35 wt %-3.55 wt %, |
| Silicon (Si) | : | 1.35 wt %-2.5 wt %, |
| Boron (B) | : | 0.7 wt %-1.2 wt %, |
| Molybdenum (Mo) | : | 0.3 wt %-1.8 wt %, |
| Manganese (Mn) | : | 0.35 wt %-0.90 wt %, |
| Carbon (C) | : | 0.01 wt %-0.20 wt %, |
| Niobium (Nb) | : | up to 1.5 wt %, |
| Copper (Cu) | : | up to 0.2 wt %, |
| Cobalt (Co) | : | up to 1.0 wt %, |

the balance being iron (Fe) and unavoidable impurities not exceeding 0.3 wt %. In a preferred embodiment thereof, carbon (C) is below 0.15 wt %.

In a particularly preferred embodiment of the present alloys, there is herein disclosed an iron-chromium based alloy consisting of by weight of total weight of alloy:

| | | |
|---|---|---|
| Chromium (Cr) | : | 22 wt %-28 wt %, |
| Nickel (Ni) | : | 2.5 wt %-3.5 wt %, |
| Silicon (Si) | : | 1.7 wt %-2.3 wt %, |
| Boron (B) | : | 0.9 wt %-1.1 wt %, |
| Molybdenum (Mo) | : | 0.3 wt %-1.8 wt %, |
| Manganese (Mn) | : | 0.35 wt %-0.70 wt %, |
| Carbon (C) | : | 0.01 wt %-0.20 wt %, |
| Niobium (Nb) | : | up to 1.5 wt %, |
| Copper (Cu) | : | up to 0.2 wt %, |
| Cobalt (Co) | : | up to 1.0 wt %, |

the balance being iron (Fe) and unavoidable impurities not exceeding 0.3 wt %. In a preferred embodiment thereof, carbon (C) is below 0.15 wt %. In a further preferred embodiment thereof, chromium (Cr) is from 22 wt % to 25 wt %.

In the alloys of the invention, the total level of unwanted impurities which are not oxygen should not exceed 0.4 wt %. Nitrogen as an unwanted impurity from powder atomization should not exceed 0.15 wt %, and other unwanted impurities which are not oxygen should not exceed 0.3 wt %.

In embodiments of the present invention, below 0.3 wt % of iron can be replaced by one or more of titanium, vanadium, aluminum or tungsten as unavoidable impurities without influencing the properties of the present alloy, which makes material sourcing cheaper. Preferably their content is kept as low as possible, such as below 0.2 wt %, or more preferably below 0.1 wt %. However, and most preferably, none of these elements are present in the alloys of the invention in below the level of insignificant impurities as the material properties are improved when these elements are largely absent.

In general, when the alloys of the present invention had not been formulated as a powder by water atomization, the content of further impurities was generally below 0.1 wt %, with oxygen and nitrogen only being introduced to the alloys subsequently when atomizing the alloys to powder.

In an aspect of the present invention, there is herein detailed an iron-chromium based alloy on powder form.

In an embodiment thereof, there is herein detailed an iron-chromium based alloy on powder form, wherein oxygen (O) as an unavoidable impurity does not exceed 0.6 wt % by weight of total weight of alloyed powder.

Accordingly, in accordance with the embodiments of the present disclosure, the total content of unavoidable impurities shall not exceed 0.8 wt % based on the total weight of a present iron-chromium based alloy, but preferably does not exceed 0.75 wt %, 0.7 wt %, 0.65 wt %, 0.6 wt %, or 0.5 wt % based on the total weight of an iron-chrome based alloy according to the present disclosure. More preferably, only oxygen (O) and nitrogen (N) are present as unavoidable impurities in contents individually exceeding 0.05 wt %, wherein oxygen (O) should only be contained in a content up to 0.3 wt % as an unavoidable impurity, and nitrogen (N) only up to 0.15 wt % nitrogen (N) as an unavoidable impurity.

In preferred embodiments of the present invention the iron-chromium based alloy on powder form comprises at least 80% by weight of iron-chromium based alloy powder contained within a sieved fraction of the iron-chromium based alloy powder having a size distribution from 1 μm to 100 μm, from 2.5 μm to 90 μm, from 5 μm to 80 μm, preferably from 10 μm to 75 μm or from 15 μm to 70 μm, or more preferably from 20 μm to 60 μm as measured by sieving in accordance with ASTM B 214.

In preferred embodiment of the present invention, the iron-chromium based alloy on powder form comprises at least 80%, at least 85% by weight, preferably at least 90% by weight, or more preferably at least 95% by weight of the iron-chromium based alloy powder having a size distribution from 2.5 μm to 100 μm as measured by sieving in accordance with ASTM B 214. More preferably, comprises at least 80%, at least 85% by weight, preferably at least 90% by weight, or more preferably at least 95% by weight of the iron-chromium based alloy powder having a size distribution from 10 μm to 80 μm as measured by sieving in accordance with ASTM B 214, or even more preferably comprises at least 80%, at least 85% by weight, preferably at least 90% by weight, or more preferably at least 95% by weight of the iron-chromium based alloy powder having a size distribution from 20 μm to 60 μm as measured by sieving in accordance with ASTM B 214.

If particles having a size below 20 μm have to be measured, laser diffraction ASTM B822 method can be used for establishing the particle size.

In a further aspect of the present invention, there is herein detailed a composition for forming therefrom an iron-chromium based alloy according to any aspect of the iron-chromium alloy detailed herein, the composition consisting of by weight of total weight of the composition of:

| | | |
|---|---|---|
| Chromium (Cr) | : | 20.5 wt %-28.0 wt %, |
| Nickel (Ni) | : | up to 5.0 wt %, |
| Silicon (Si) | : | 0.5 wt %-2.5 wt %, |
| Boron (B) | : | 0.50 wt %-1.5 wt %, |
| Molybdenum (Mo) | : | 0.15 wt %-2.0 wt %, |
| Manganese (Mn) | : | 0.10 wt %-0.90 wt %, |
| Carbon (C) | : | 0.01 wt %-0.20 wt %, |
| Niobium (Nb) | : | up to 1.5 wt %, |
| Copper (Cu) | : | up to 0.2 wt %, |
| Cobalt (Co) | : | up to 1.0 wt %, |

the balance being iron (Fe) and unavoidable impurities not exceeding 0.3 wt %.

In the preferred embodiment of the present composition, the composition is adapted in its composition to match any iron-chromium based alloy disclosed herein.

Typically, but not necessarily, the individual elements of the composition will be provided directly as elemental metal. However, in some embodiments one or more of the components of the composition will be pre-alloyed prior to addition to the composition of the invention, e.g., in the form of scrap metal from reusable sources.

For forming the alloys of the present invention, the composition of the present invention is heated above melting of its main constituent elements and the alloys of the present invention formed thereby.

In a further aspect of the present invention there is herein detailed the use of a powder according to any embodiment detailed herein for the coating of a surface by means of a laser cladding method.

In a further aspect of the present invention there is herein detailed an iron-chromium based alloy formed in a laser cladding method from an iron-chromium based alloy according to any of the herein detailed embodiments thereof.

In a further aspect of the present invention, there is herein detailed a surface coating consisting of an iron-chromium based alloy according to any of the herein detailed embodiments thereof.

In a further aspect of the present invention, there is herein detailed a shaped object comprising a surface coating consisting of an iron-chromium based alloy according to any of the herein detailed embodiments thereof.

In a further aspect of the present invention, there is herein detailed a method for the production of a coated surface or of an object, having the steps:
provision of a powder according to one or more of the herein detailed embodiments thereof in a form or formulation that is suitable for laser cladding;
carrying-out of a laser cladding process using this powder;
obtaining of the desired surface coating or of the desired object.

### EXAMPLES

### Example 1—Manufacture of Alloys and Impurities Contained

In accordance with the present disclosure and invention, the following iron-chromium alloys on powder form were tested for their suitability for solving the objectives of the present disclosure, c.f. Tables 1 and 2.

Alloys according to Tables 1 and 2 were produced by joint melting of the constituents in a test scale of approximately 10 kg furnace. Some of the tests were repeated in a large scale 200 kg furnace. Alloys on powder form as reported in Tables 1 and 2 for testing in laser cladding experiments were atomized after alloying using one of either gas atomization (GA), water atomization (WA), or high-pressure water atomization (HPWA).

### Measurements of Particle Size Distribution:

Particle size distribution was measured using a Ro-TAP sieve shaker or laser diffraction.

Using a Ro-Tap sieve shaker the powder particles were shaken down through a stack of metallic sieves with different openings by an oscillating motion. The weight of the powder on each sieve was subsequently weighted using a calibrated scale and the fraction powder weight normalized to total powder weight. Sieve analysis using Ro-Tap sieve is performed according to ASTM B 214.

Laser diffraction analysis was performed using an analyzer from Sympatec. Measurements were performed according to ASTM B822.

### Impurities Detected in the Raw Materials:

Impurities found in the raw materials include Cu, Co, A1, S, and P.

In experiments not reported herein, it was found that when copper (Cu) exceeds 0.2 wt % of the iron-chromium based alloy, solidification cracks in the laser clad surfaces start to form.

Hence, in the present alloys, if copper (Cu) is present, the content of copper shall not exceed 0.2 wt %, preferably shall not exceed 0.1 wt % based on the total weight of the alloy. Most preferred however, copper is present only as an unavoidable impurity. In the experiments reported herein, copper (Cu) is essentially absent, i.e., below the analytical detection limit.

In experiments not reported herein, it was found that cobalt (Co) can be present up to 1.0 wt % of the iron-chromium based alloy without affecting the properties of laser clad surfaces coated with the alloys of the present disclosure. Accordingly, inclusion of cobalt (Co) up to 1.0 wt % in the alloys of the present disclosure as a non-influencing filler is possible, however it is highly undesirable as the carcinogenic potential of cobalt containing powders makes the inclusion of more than 0.2 wt % cobalt (Co) as a filler undesirable for health and safety reasons. Most preferably, cobalt is present only as an unavoidable impurity. In the experiments reported herein, cobalt (Co) is essentially absent, i.e., below the analytical detection limit.

Aluminum (Al) was present in raw materials initially tested but not reported herein up to 0.1 wt % based on the total mass of the iron-chromium based alloy of the present disclosure as an unavoidable impurity without influencing the alloys of the present invention. Preferably raw materials having only 0.05 wt % aluminum as an unavoidable impurity were used for the present experiments, however in the experiments reported herein, aluminum (Al) is essentially absent, i.e., below the analytical detection limit.

Phosphor and sulfur as unavoidable impurities in the herein reported alloys were respectively detected at levels below 0.05 wt %.

Alloys that were atomized by one of either gas atomization (GA), water atomization (WA) or high-pressure water atomization (HPWA) contained up to 0.5 wt % oxygen (O) as an unavoidable impurity, and up to 0.15 wt % nitrogen (N) as an unavoidable impurity. Generally, the combined content of oxygen and nitrogen as unavoidable impurities did not exceed 0.3 wt % based on the total weight of the iron-chromium based alloys of the present disclosure, with combined contents of 0.25 wt %, 0.20 wt %, 0.15 wt %, or 0.10 wt % being obtainable.

Accordingly, in accordance with the embodiments of the present disclosure, the total content of unavoidable impurities shall not exceed 0.8 wt % based on the total weight of a present iron-chromium based alloy, but preferably does not exceed 0.75 wt %, 0.7 wt %, 0.65 wt %, 0.6 wt %, or 0.5 wt % based on the total weight of an iron-chrome based alloy according to the present disclosure. More preferably, only oxygen (O) and nitrogen (N) are present as unavoidable impurities in contents individually exceeding 0.05 wt %, wherein oxygen (O) should only be contained in a content up to 0.3 wt % as an unavoidable impurity, and nitrogen (N) only up to 0.15 wt % nitrogen (N) as an unavoidable impurity.

### Example 2—Alloys on Powder Form Examined in Laser Cladding

Alloys reported in Table 1 on powder form were prepared by water atomizing a melt having the alloy composition as reported in the present table. Nitrogen and oxygen are impurity inclusions resulting from the water atomization process. With the exception of sample A11, which was high-pressure water atomized, and A41, which was gas atomized, all powders samples reported herein were manufactured by water atomization from melt. After atomizing the powders were dried and sieved to a size fraction of from between 20 μm to 63 μm, considered suitable in the subsequent laser cladding experiments. In the table, n.d. is not detected, while a * next to a sample number indicates that the sample is comparative to the alloys of the present invention.

Sample A35 is comparative, wherein a low chromium alloy was tested. The alloy performed unsatisfactorily with respect to the targets of the present disclosure e.g., as assessed by micro and/or macro cracks formation in accordance with the definitions given herein below. When the chromium content became lower than the herein detailed limits, macro cracks would start to form during laser cladding leading to a breakdown of the coating.

Overall, coatings with thicknesses between 100 to 350 μm were produced in laboratory scale using clad speeds between 30 and 100 m/min and deposition rates between 0.5 to 1.5 m²/h. The coatings of the present alloys as produced were free from cold cracks and showed a hardness between 400-450 HV; and a corrosion resistance in NSS>>96 h.

TABLE 1
Alloy compositions tested-Fe (bal)

| Smpl | Cr | Ni | Si | B | Mo | Mn | C | O | N | Nb |
|---|---|---|---|---|---|---|---|---|---|---|
| # | wt % | wt % | wt % | wt % | wt % | wt % | wt % | wt % | wt % | wt % |
| A1 | 20.7 | 2.93 | 1.41 | 0.72 | 0.40 | 0.60 | 0.057 | 0.20 | 0.01 | — |
| A2 | 25.0 | 3.00 | 2.10 | 0.73 | 0.40 | 0.66 | 0.059 | 0.12 | 0.01 | — |
| A3 | 20.8 | 3.00 | 2.18 | 1.14 | 0.38 | 0.71 | 0.05 | 0.11 | 0.01 | — |
| A4 | 25.0 | 2.90 | 1.55 | 1.05 | 0.40 | 0.72 | 0.06 | 0.27 | 0.02 | — |
| A5 | 21.3 | 3.10 | 2.17 | 0.74 | 0.38 | 0.73 | 0.16 | 0.10 | 0.01 | — |
| A6 | 24.8 | 2.80 | 1.50 | 0.68 | 0.40 | 0.64 | 0.17 | 0.21 | 0.01 | — |
| A7 | 20.8 | 2.80 | 1.60 | 1.20 | 0.40 | 0.66 | 0.15 | 0.14 | 0.01 | — |
| A8 | 25.2 | 2.80 | 2.30 | 1.20 | 0.27 | 0.69 | 0.15 | 0.10 | 0.02 | — |
| A9 | 22.8 | 3.00 | 2.00 | 1.01 | 0.39 | 0.49 | 0.10 | 0.09 | 0.02 | — |
| A10 | 22.8 | 3.50 | 1.60 | 1.00 | 0.40 | 0.60 | 0.10 | 0.24 | 0.04 | — |
| A11 | 22.6 | 2.90 | 2.40 | 1.01 | 0.43 | 0.47 | 0.11 | 0.11 | 0.07 | — |
| A12 | 22.7 | 3.12 | 2.39 | 1.01 | 0.41 | 0.53 | 0.08 | 0.13 | 0.13 | — |
| A13 | 21.0 | 3.0 | 1.70 | 0.80 | 0.4 | 0.6 | 0.05 | 0.10 | n.d. | — |
| A14 | 21.5 | 3.0 | 1.70 | 1.30 | 0.4 | 0.6 | 0.14 | 0.09 | n.d. | — |
| A15 | 24.8 | 3.0 | 2.30 | 1.16 | 0.4 | 0.6 | 0.16 | 0.12 | n.d. | — |
| A16 | 20.8 | 3.20 | 2.10 | 0.86 | 0.40 | 0.66 | 0.04 | 0.11 | 0.01 | — |
| A17 | 24.7 | 3.20 | 2.40 | 0.88 | 0.40 | 0.56 | 0.07 | 0.10 | 0.02 | — |
| A20 | 23.1 | 3.00 | 2.00 | 0.86 | 0.41 | 0.45 | 0.125 | 0.090 | 0.014 | — |
| A21 | 23.2 | 3.10 | 2.00 | 0.72 | 0.39 | 0.46 | 0.075 | 0.090 | 0.015 | — |
| A22 | 23.5 | 3.05 | 2.00 | 0.74 | 0.41 | 0.48 | 0.178 | 0.083 | 0.014 | — |
| A23 | 23.7 | 3.03 | 2.03 | 1.04 | 0.42 | 0.49 | 0.075 | 0.091 | 0.012 | — |
| A24 | 23.5 | 3.03 | 2.05 | 1.08 | 0.43 | 0.52 | 0.184 | 0.086 | 0.012 | — |
| A25 | 22.9 | — | 1.90 | 0.88 | 0.42 | 0.58 | 0.119 | 0.129 | 0.012 | — |
| A28 | 23.7 | 3.16 | 2.06 | 1.01 | 0.37 | 0.60 | 0.087 | 0.088 | 0.017 | — |
| A35* | 18.7 | 3.06 | 1.92 | 0.97 | 0.39 | 0.71 | 0.114 | 0.097 | 0.011 | — |
| A36 | 24.9 | 3.10 | 1.95 | 1.04 | 0.38 | 0.57 | 0.110 | 0.093 | 0.014 | — |
| A38 | 23.2 | 2.90 | 2.20 | 1.03 | 1.50 | 0.73 | 0.021 | — | — | — |
| A39 | 23.4 | 3.00 | 2.2 | 0.38 | 0.71 | 1.01 | 0.020 | 0.072 | 0.008 | — |
| A40 | 23.3 | 3.00 | 1.9 | 1.02 | 1.6 | 0.62 | 0.099 | 0.092 | 0.026 | — |
| A41 | 23.1 | 3.00 | 2.00 | 1.00 | 0.40 | 0.66 | 0.107 | 0.041 | 0.037 | — |
| A42 | 25.2 | 2.90 | 2.00 | 1.06 | 0.39 | 0.57 | 0.109 | 0.106 | 0.023 | — |
| A43 | 27.1 | 2.90 | 2.00 | 1.05 | 0.40 | 0.57 | 0.101 | 0.109 | 0.023 | — |
| A44 | 22.95 | 4.68 | 1.73 | 0.94 | 0.46 | 0.62 | 0.090 | — | — | — |

### Example 3—Alloys on Powder Form Containing Niobium Examined in Laser Cladding

Alloys reported in Table 2 on powder form were prepared by water atomizing a melt having the alloy composition as reported in the present table. Nitrogen and oxygen are impurity inclusions resulting from the water atomization process. All powders samples reported herein were manufactured by water atomization from melt. After atomizing the powders were dried and sieved to a size fraction of from between 20 μm to 63 μm, considered suitable in the subsequent laser cladding experiments. In the table, n.d. is not detected, while a * next to a sample number indicates that the sample is comparative to the alloys of the present invention.

For the alloys of the present invention reported in Example 2 in laser cladding experiments, it was found that although the alloys would perform to specification in general, when one or both of either carbon or boron exceeded 0.15 wt % (C) or 1.1 wt % (B) respectively, or both in combination exceeded 1.2 wt %, the number macro or solidification cracks formed during laser cladding increased compared to other alloys of the present invention.

In subsequent experiments for the alloys reported in Table 2, it was found that niobium (Nb) was suitable for suppressing crack formation, such as cracks visible to the eye, in high content (i.e., exceeding the above given contents' limits) carbon and/or boron alloys while being a neutral additive for other concentrations of carbon, respectively boron, or both carbon and boron in combination.

TABLE 2
Alloy compositions tested with Niobium-Fe (bal)

| | Cr | Ni | Si | B | Mo | Mn | C | O | N | Nb |
|---|---|---|---|---|---|---|---|---|---|---|
| Smpl # | wt % | wt % | wt % | wt % | wt % | wt % | wt % | wt % | wt % | wt % |
| A26 | 23.2 | 3.06 | 2.02 | 1.15 | 0.36 | 0.57 | 0.162 | 0.104 | 0.013 | 0.52 |
| A27 | 23.4 | 3.06 | 2.02 | 1.17 | 0.37 | 0.59 | 0.163 | 0.087 | 0.013 | 1.00 |
| A29 | 23.7 | 3.00 | 2.00 | 0.98 | 0.46 | 0.58 | 0.110 | 0.094 | 0.013 | 0.49 |
| A30 | 23.5 | 3.00 | 2.00 | 0.73 | 0.44 | 0.58 | 0.118 | 0.117 | 0.014 | 0.48 |
| A31 | 22.9 | 2.88 | 2.04 | 1.30 | 0.44 | 0.62 | 0.174 | 0.076 | 0.012 | 0.49 |
| A32 | 23.4 | 2.83 | 1.89 | 1.33 | 0.39 | 0.56 | 0.175 | 0.077 | 0.012 | 0.94 |
| A33 | 23.0 | 3.00 | 1.90 | 1.10 | 0.40 | 0.60 | 0.103 | 0.097 | 0.014 | 0.90 |
| A34 | 23.0 | 3.00 | 2.00 | 0.90 | 0.40 | 0.60 | 0.085 | 0.078 | 0.015 | 1.00 |

### Experimental Setup and Methods

### High-Speed Laser Cladding

In the context of the present invention, high-speed laser cladding refers to laser cladding processes which operate at clad speeds in excess of 1 m/min. In the experiments reported herein below, clad speeds of 30 m/min respectively 100 m/min were used.

Powders of the alloys reported in Tables 1 and 2 were (high-speed) laser cladded according to the experimental settings and parameters detailed in Table 3. One and two-layer coatings were produced using a HighNo4 nozzle, or a 6-jet GTV nozzle. Low C-steel rods with 50 mm in diameter and 200 mm in length were used for the experiments with HighNo 4.0 nozzle, and low C-steel rods with 80 mm in diameter were used for the experiments with the 6-jet GTV nozzle.

For evaluation of the coating properties of the steel rods, such as microstructure and hardness, evaluations were performed on 30 mm long, one-layer coatings (also known in the art as clads), produced using two clad speeds of 30 m/min respectively 100 m/min.

For evaluation of the corrosion properties of the steel rods, 90 mm long two-layer coatings were produced using the same two clad speeds of 30 m/min and 100 m/min as for the one-layer coatings.

TABLE 3
Experimental parameters used in laser cladding.

| | Power | Speed | Feed rate | Spot Ø | Overlap |
|---|---|---|---|---|---|
| Nozzle | [W] | [m/min] | [g/min] | [mm] | [%] |
| HighNo4 | 2.6 | 30 | 25 | 1.5 | 94 |
| HighNo4 | 3.5 | 100 | 25 | 1.5 | 78 |
| GTV | 6 | 50 | 55 | 3.3 | n.a. |

### Evaluation of Coating Properties—Method

### Samples Coated Using the HighNo 4.0 Nozzle:

The 30 mm long one-layer coatings produced using the HighNo 4.0 nozzle were tested for cracks using dye penetrants.

The samples were cut perpendicular to the cladding direction, mold ground and polished using standard methods for metallographic sample preparation.

Hardness Vickers HV0.2 was measured in the coatings cross section using 200 g load. Seven indents were made, and the average and scatter calculated.

The samples were etched in Nital 4% to highlight the coating and better distinguish it from the substrate. The coating quality was judged as follows:
The number of pores and slag with diameter between 50-25 μm were counted in an area of approx. 35 mm×0.25 mm.
The number of “hot cracks” also called microcracks was estimated qualitatively by inspecting a coating area of 35 mm×0.25 mm in 5× magnification.
The number of microcracks was ranked from 1 to 5 according to Table 4.

TABLE 4
Ranking scheme for evaluation of
microcrack severity in laser clad coatings

| Ranking | Criteria |
|---|---|
| 5 | Very Many |
| 4 | Many |
| 3 | Intermediate |
| 2 | Some |
| 1 | Few |

The microstructure of the coatings was further investigated by light optical microscopy (LOM) and SEM. For LOM analysis, the samples were etched in Vilella (94 ml EtOh+5 ml HCl+1 gr Picric acid). For some selected samples EBSD-SEM analysis was performed. Unetched samples polished for 20 min using colloidal SiO2 (OP-U from Struers) were used for EBSD-SEM analysis.

Neutral Salt Spray testing (NSS-testing) was performed on 90 mm long two-layer clads according to ASTM B117 current version (2022) in accordance with the test conditions reported in Table 5.

TABLE 5
Test conditions for Neutral Salt Spray Test (NSS)

| | |
|---|---|
| Temperature | 35° C. ± 2° C. |
| Average collection rate for a | 1.5 ml/h ± 0.5 ml/h |
| horizontal collecting area of 80 cm² | |
| Concentration of NaCl | 50 g/l ± 5 g/l |
| pH | 6.5 to 7.2 |

Prior to the NSS tests, the samples were ground to a surface roughness Rₐ of approx. 0.8-1 μm. During grinding there was no possibility to control the material removal and the samples were ground until a smooth and even surface was obtained. Surface smoothness was judged by eye inspection.

The samples were kept in the NSS chamber for seven days and analyzed after 24 hours, 48 hours, and 168 hours. The samples were ranked qualitatively according to ISO 10289, current version (2022), using the ranking criteria given in Table 6.

TABLE 6
Qualitative ranking scale used for evaluating
corrosion resistance according to ISO 10289

| Ranking | Criteria |
|---|---|
| 10 | No defects in the sample |
| 9 | Very few surface defects |
| 8 | Few surface defects |
| 7-6 | Moderate surface defects |
| 5 | Severe surface defects |

### Samples Coated Using the 6-Jet GTV Nozzle:

The samples coated using the GTV nozzle were tested for cracks using dye penetrant. Hardness HV0.3 was measured in the coating cross section and coating quality was judged using LOM.

### Results and Discussion

### Evaluation of Coating Properties

### Calculated Thermodynamic Properties—Samples A1-A9

The thermodynamic properties of the alloys A1-A9 of Table 1 were calculated (using the pre-alloying target values in accordance with Table 7 for the alloy compositions, rather than the post-alloying experimentally determined actual compositions) with the aim of obtaining a more in-depth understanding of the coating properties. Additionally, the phase amounts and compositions of the alloys at a temperature of 200 degrees below the solidus were calculated for assessing a theoretical level for the stability of the alloy to process variations under equilibrium conditions.

The melting interval (difference between solidus and liquidus), ΔT, was calculated to estimate the sensitivity of the alloy to solidification cracking. The alloys tendency to segregate was also captured by calculating the Scheil solidification interval (SSI) of the last 10% of melt.

As known in the art, some alloying elements have a strong tendency to segregation which results in a large melting interval. The larger the melting interval the more prone the alloy is to solidification cracking or “hot cracks”, however the alloys reported in Table 7 all performed to expectations.

PREN was calculated using the chemical composition of austenite at 200° C. below the solidus temperature using the equation: PREN=100 (W(FCC,CR)+3.3W(FCC,MO)) for all alloys except A2 (marked with *), which was calculated assuming a bcc-matrix.

The parameters for the calculations are listed below.
Grain size set at 10 μm.
Intercritical annealing temperature was set to at 200° below the solidus.

TABLE 7
Calculated thermodynamic properties of alloys A1 to A9
calculated using the nominal chemical composition.

| Alloy # | Cr | B | C | Si |
|---|---|---|---|---|
| A1 | 20.5 | 0.8 | 0.05 | 1.7 |
| A2 | 24.5 | 0.8 | 0.05 | 2.3 |
| A3 | 20.5 | 1.2 | 0.05 | 2.3 |
| A4 | 24.5 | 1.2 | 0.05 | 1.7 |
| A5 | 20.5 | 0.8 | 0.15 | 2.3 |
| A6 | 24.5 | 0.8 | 0.15 | 1.7 |
| A7 | 20.5 | 1.2 | 0.15 | 1.7 |
| A8 | 24.5 | 1.2 | 0.15 | 2.3 |
| A9 | 22.5 | 1.0 | 0.10 | 2.0 |

| | | | | NPM | NPM | NPM | PREN | |
|---|---|---|---|---|---|---|---|---|
| Liquidus | Solidus | | ΔT | BCC | FCC | M2B | FCC | Ms |
| T (K) | T (K) | ΔT | Sheil | T₂₀₀ | T₂₀₀ | T₂₀₀ | T₂₀₀ | T₂₀₀ |
| 1675 | 1550 | 125 | 55 | 0.50 | 0.39 | 0.12 | 16.6 | 381 |
| 1672 | 1566 | 106 | 48 | 0.88 | 0.00 | 0.12 | 18.7* | — |
| 1636 | 1551 | 85 | 96 | 0.40 | 0.43 | 0.17 | 15.6 | 382 |
| 1639 | 1557 | 82 | 46 | 0.71 | 0.12 | 0.17 | 17.9 | 299 |
| 1660 | 1533 | 127 | 46 | 0.32 | 0.56 | 0.12 | 17.2 | 294 |
| 1665 | 1515 | 150 | 58 | 0.71 | 0.16 | 0.12 | 18.2 | 300 |
| 1629 | 1538 | 91 | 48 | 0.00 | 0.83 | 0.17 | 17.0 | 333 |
| 1626 | 1520 | 106 | 57 | 0.62 | 0.19 | 0.17 | 17.5 | 275 |
| 1668 | 1539 | 129 | 58 | 0.61 | 0.28 | 0.12 | 17.9 | 287 |

### Coating Properties

HighNo 4.0 Nozzle, Clad Speed 30 and 100 m/Min
Clad Speed 30 m/Min

Tables 8 and 9 summarizes the experimental results for various coatings prepared using the HighNo 4.0 nozzle at a clad sped of 30 m/min, without (Table 8) and with (Table 9) niobium (Nb) present in the alloys.

Noticeably, all alloys of the present disclosure clad the sample surfaces without macrocrack formation, with the exemption of alloys A7, A8 and A35. The failure of alloys A7, and A8 to prevent macrocrack formation was found to be correlated with high total content of boron and carbon, in excess of 1.2 wt % total boron and carbon, which however as documented in Table 9, could be compensated for by the addition of niobium. Alloy A35, wherein the chromium content is 18.70 wt %, is comparative only to the alloys of the present invention, as it was found that when chromium was present outside the herein detailed limits, macrocrack formation could not otherwise be suppressed by adjustment within the herein detailed limits of the content of other constituents pertaining to the present alloys.

TABLE 8
Coating properties of alloys-Nb not present

| Alloy | Macro | Micro | Hardness | HV | Micro | | |
|---|---|---|---|---|---|---|---|
| # | Cracks | Cracks | HV0.2 | scatter | structure | Porosity | NSS |
| A1 | 1 | 4 | 361 | 13 | Even | 0 | N.A. |
| A2 | 1 | 5 | 388 | 7 | Even | 2 | N.A. |
| A3 | 1 | 1 | 472 | 10 | Even | 1 | 8 |
| A4 | 1 | 1 | 428 | 17 | Even | 5 | 9 |
| A5 | 1 | 3.5 | 384 | 10 | Even | 6 | 6 |
| A6 | 1 | 1 | 395 | 15 | Even | 5 | 7 |
| A7 | 5 | 1 | 480 | 25 | Uneven | 2 | 9 |
| A8 | 5 | 1 | 460 | 25 | Even | 1 | N.A. |
| A10 | 1 | 1 | 433 | 17 | Even | 3 | 9 |
| A11 | 1 | 1 | 459 | 20 | Even | 6 | 9 |
| A12 | 1 | 1 | 456 | 22 | Even | 3 | 9 |
| A16 | 1 | 1 | 355 | 19 | Even | 2 | 7 |
| A17 | 1 | 1 | 424 | 9 | Even | 8 | 9 |
| A20 | 1 | 2.5 | 401 | 10 | Even | 8 | 7 |
| A21 | 1 | 5 | 382 | 5 | Even | 28 | 7 |
| A22 | 1 | 4 | 395 | 10 | Even | 2 | 6 |
| A23 | 1 | 1 | 439 | 18 | Even | 5 | 9 |
| A24 | 1 | 1 | 441 | 15 | Even | 6 | 9 |
| A25 | 1 | 2.5 | 391 | 17 | Even | 1 | N.A. |
| A28 | 1 | 2 | 418 | 12 | Even | 2 | 9 |
| A35* | 5 | 2 | 424 | 17 | Even | N.A. | 5 |
| A36 | 1 | 2 | 431 | 36 | Even | N.A. | 10 |
| A39 | 1 | 1 | 433 | 12 | Even | 7 | 9 |
| A40 | 1 | 1 | 452 | 9 | Even | 6 | 9 |
| A41 | 1 | 1 | 437 | 13 | Even | 1 | 8 |
| A43 | 1 | 1 | 439 | 11 | Even | N.A. | 9-10 |
| A44 | 1 | 2 | 427 | 13 | Even | 4 | 9 |

TABLE 9
Coating properties of alloys-Nb present

| Alloy | Macro | Micro | Hardness | HV | Micro | | |
|---|---|---|---|---|---|---|---|
| # | Cracks | Cracks | HV0.2 | scatter | structure | Porosity | NSS |
| A26 | 1 | 1 | 441 | 15 | Even | 0 | 9 |
| A27 | 1 | 1 | 459 | 8 | Even | 8 | 8 |
| A29 | 1 | 1 | 414 | 8 | Even | 2 | 9 |
| A30 | 1 | 3 | 379 | 5 | Even | 6 | 6 |
| A31 | 1 | 2 | 511 | 9 | Even | 14 <25 μm | 0 |
| A32 | 1 | 1 | 491 | 13 | Even | 12 | 0 |
| A33 | 1 | 1 | 445 | 8 | Even | 14 | 8 |
| A34 | 1 | 1 | 402 | 10 | Even | 14 | 9 |

Clad Speed 100 m/Min

The experiments performed at a clad speed of 100 m/min reproduced the experiments for the clad speed of 30 m/min, showing that the present alloys are suitable also for very fast high-speed laser cladding. Alloys A7, A8 again were found to present with a high number of macrocracks (test score of 5), which again was fully compensated for by the addition of niobium. The surface coated with alloy A35 also obtained a test score of 5, which could not otherwise be compensated for by adjustment of other elements of the present alloys. A few of the further alloys presented with slightly worse scores than at 30 m/min emphasizing the need for individual optimization of the cladding speed for a given alloy.

Coating Properties—GTV-Nozzle, Clad Speed 50 m/Min

In a smaller experimental study, alloys A1 through A11 (minus A9) were tested using a GTV-nozzle at a clad speed of 50 m/min (c.f. Table 10). The results proved comparable to the results for the HighNo 4.0 nozzle at a clad speed of 100 m/min.

TABLE 10
GTV-nozzle

| Alloy | Macro | Micro | | HV | Micro | | |
|---|---|---|---|---|---|---|---|
| # | Cracks | Cracks | HV0.3 | scatter | structure | Porosity | NSS |
| A1 | 1 | NA | 346 | 19 | NA | NA | NA |
| A2 | 2* | NA | 373 | 15 | NA | NA | NA |
| A3 | 1 | NA | 445 | 8 | NA | NA | NA |
| A4 | 1 | NA | 425 | 10 | NA | NA | NA |
| A5 | 2* | NA | 394 | 11 | NA | NA | NA |
| A6 | 2* | NA | 379 | 10 | NA | NA | NA |
| A7 | 5 | NA | 454 | 9 | NA | NA | NA |
| A8 | 5 | NA | 470 | 13 | NA | NA | NA |
| A10 | 1 | 2 | 420 | 10 | 2 | NA | Pass |
| A11 | 1 | 2 | 448 | 10 | 3 | NA | Pass |

### Discussion

### Hardness

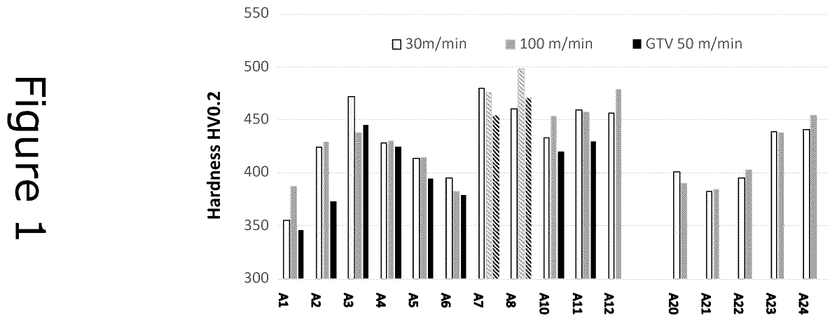

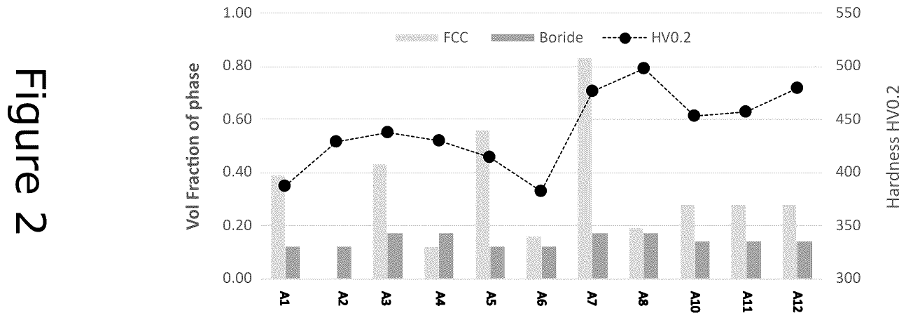

FIG. 1 shows hardness HV0.2 for alloys A1-A8, A10-A12, and A20-A24 cladded at 30 and 100 m/min using the HighNo 4.0 nozzle and cladded at 50 m/min with the GTV nozzle. In FIG. 1, the striped bars for alloys A7 and A8 reflect that these two alloys showed macrocracks after cladding.

It can be observed that for the same alloy chemistry hardness HV0.2 is in the same range independently of the clad speed and nozzle used. Hardness is somewhat lower for the clads produced using the GTV nozzle most probably due to a lower solidification rate. Further, the hardness HV0.2 varies from approx. 350 HV0.2 to 500 HV0.2. While these hardness variations are significant, they can be explained by the large variations in carbon and boron content in the investigated alloys, consistent with the alloys having the lowest content of carbon and boron showing the lowest hardness, while the alloys with the highest carbon and boron content showing the highest hardness.

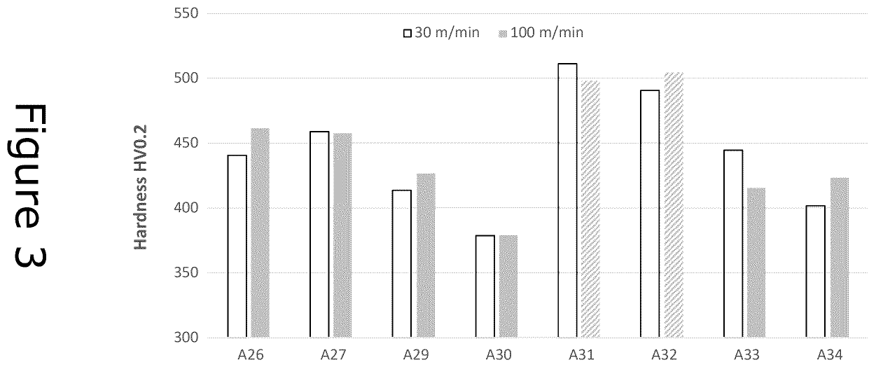

In FIG. 2, the hardness of alloys A1-A8 and A10-A12 are plotted vs the calculated volume fractions of borides and austenite at 200° C. below the solidus temperature, examining the correlation between the simulated microstructure and the observed coating hardness. In FIG. 2 coating hardness vs. vol fraction of borides and fcc calculated at 200° C. below the solidus and the remaining phase is Bcc. The calculations were done using the nominal composition of the alloys. The volume fraction of borides for the range of chemical compositions investigated and increased with raised boron content.

Significant variations in fcc content were observed in the calculated results. In the alloys, fcc-packed phases are expected to transform into martensite during cooling and in this contribute to the hardness. Therefore, alloys with a higher amount of initial fcc content are expected to be harder. However, no clear relation between the volume fraction of austenite and the measured hardness could be established.

In order to suppress the risk for formation of macrocracks it was decided to add Nb between 0.5-1.0 wt %. Niobium is a strong carbide former. If primary carbides are formed in the melt the austenitic matrix will be impoverished by carbon and a “softer” martensite is expected to form.

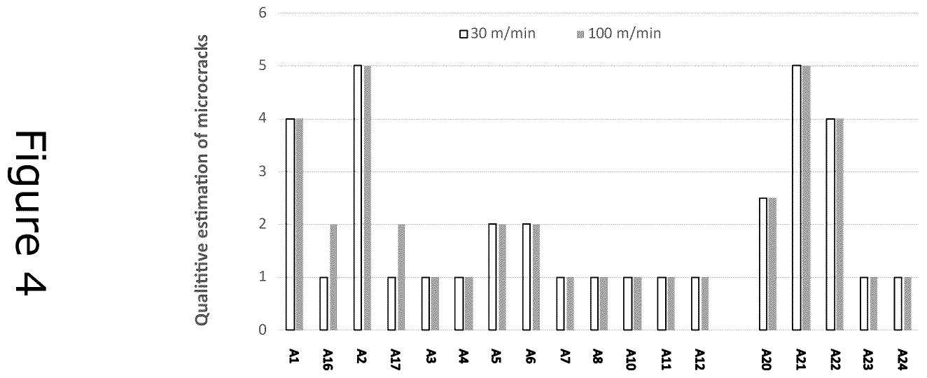

FIG. 3 shows the hardness of alloys A26-A34 containing Nb between 0.5-1.0 wt % cladded using the HighNo 4.0 nozzle at 30 and 100 m/min. The dotted staples refer to coatings with macrocracks Alloy A31 and A32 with highest C and B content (C=0.17% and B=1.30 wt.) which showed cracks when cladding using the HighNo 4.0 nozzle at a speed of 100 m/min. Alloys A26 with C=0.16 and B=1.15 and A17 with C=0.16 and B=1.17 wt % did not crack. Alloys A7 and A8 with chemical composition similar to A26 and A27 (but without Nb) showed cracks. Nb additions are therefore beneficial to suppress crack formation, particular at high carbon and/or boride content.

### Analysis of the Microstructure of the Coatings

### Pores and Slags:

Pores were found in all coatings and when cladding with the HighNo 4.0 nozzles pores were typically <50 μm in size. The number of pores and slags in the investigated coatings was counted but it was not possible to find a correlation between alloys chemical composition for example Si and O content and number of pores, c.f. Tables 7 to 10.

### Hot Cracks:

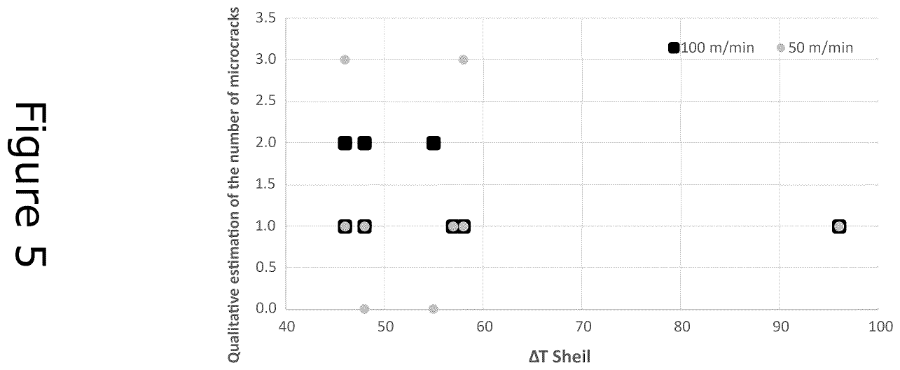

A qualitative estimation of the number of microcracks in the coatings was made for alloy A1 to A12, A16, A17 and A20-A24. The results are illustrated in FIG. 4.

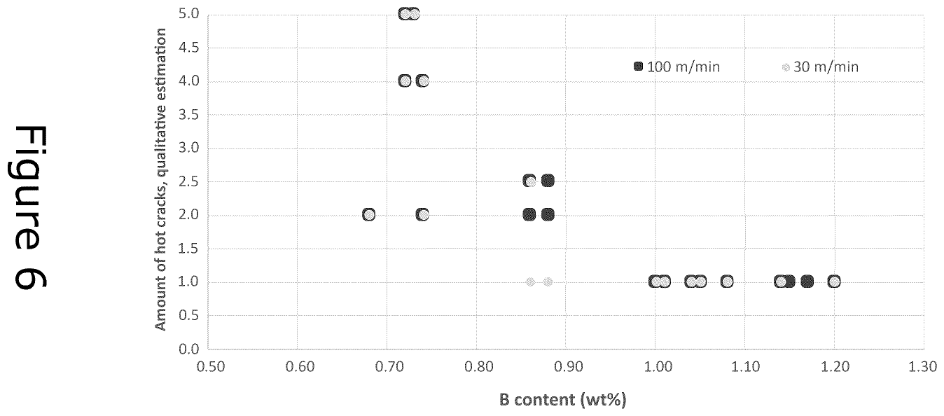

In FIG. 5, the number of microcracks was plotted vs the solidification range calculated for the last 10% of melt using Sheil simulation. This to get an indication of the alloys' segregation tendency. The melting ranges were very similar for all alloys except for A3 indicating a similar tendency to segregation in the melt. No clear correlation could be found between melting range and number of microcracks in the coatings.

By plotting the number of microcracks vs. the boron content, as done in FIG. 6, it could be observed that the number of microcracks was highest for boron contents below 0.9%. No relation between number of microcracks Si or C could be found, c.f. Table 11. FIG. 6 shows that the boron content should not be below 0.9 wt %, preferably not below 0.95 wt % to minimize the number of hot cracks and that the maximum B content should not exceed 1.5 wt %.

As carbon must be allowed to vary between 0.05 to 0.15 wt % for cost efficient selection of raw material and capability of the production process there is a risk for formation of macrocracks if both carbon and boron are simultaneously close to upper specification limit, which will need to be alleviated by the addition of niobium (Nb).

TABLE 11
Coating properties of alloy A1 to A11. GTV NOZZLE,
clad speed 50 M/MIN

| Alloy | Macro | Micro | HV | HV | Micro | | |
|---|---|---|---|---|---|---|---|
| name | Cracks | Cracks | 0.3 | scatter | structure | Porosity | NSS |
| A1 | 1 | NA | 346 | 19 | NA | NA | NA |
| A2 | 2* | NA | 373 | 15 | NA | NA | NA |
| A3 | 1 | NA | 445 | 8 | NA | NA | NA |
| A4 | 1 | NA | 425 | 10 | NA | NA | NA |
| A5 | 2* | NA | 394 | 11 | NA | NA | NA |
| A6 | 2* | NA | 379 | 10 | NA | NA | NA |
| A7 | 5 | NA | 454 | 9 | NA | NA | NA |
| A8 | 5 | NA | 470 | 13 | NA | NA | NA |
| A10 | 1 | 2 | 420 | 10 | 2 | NA | Pass |
| A11 | 1 | 2 | 448 | 10 | 3 | NA | Pass |

*Small dots (pores or small cracks) are visible on the surface
**Small 10 kg water atomized batch

### Microstructure:

The microstructure of the coatings in the as-unetched coatings were inspected to check for porosity, oxides and microcracks. The number of microcracks varied in the coatings depending on the chemical composition as shown in FIGS. 4 and 5. In overall the samples cladded at 30 m/min showed a lesser number of smaller imperfections than the samples cladded at 100 m/min.

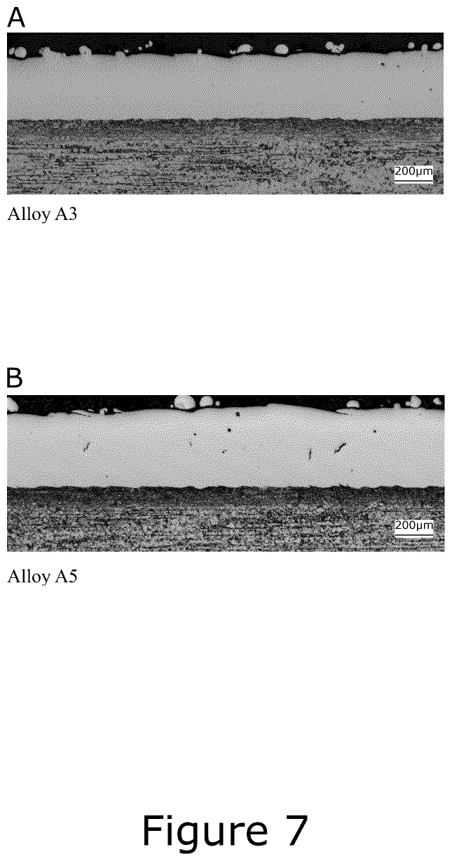

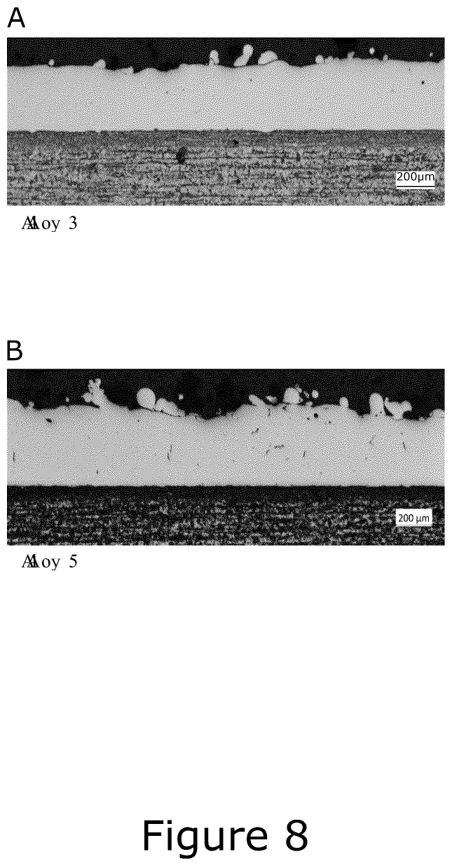

The typical microstructure of a coating with low number of pores and cracks and that of a coating with a large number of microcracks and pores is illustrated in FIGS. 7 and 8. In FIG. 7a is shown a coating of alloy A3 at 30 m/min, presenting a good coating quality with few visible pores, while in FIG. 7b is shown a coating of alloy A5 at 30 m/min, presenting a lower quality coating wherein several microcracks and pores are visible in the coating, while the same results are shown for the same alloys A3 and A5 at 100 m/min in FIG. 8, c.f. also Tables 7 to 10.

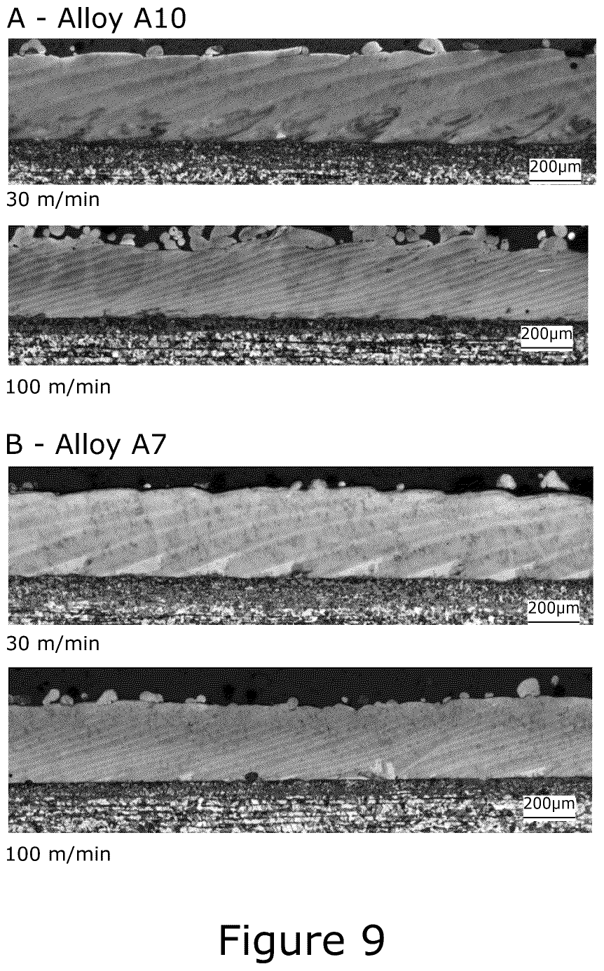

The samples were etched in Vilella to check for the coating microstructure. All coatings showed a very fine microstructure which could not be further resolved by LOM. The microstructure was even for alloys except for A7 (c.f. FIG. 9, showing two examples of microstructure for coatings with alloys A10 and A7, cladded respectively at 30 m/min and 100 m/min using an HighNo 4.0 nozzle) cladded at 30 m/min. A7 showed some tendency to form a layered structure where the light etched areas are harder than the (HV~450). Based on (HV~600) dark etched one thermodynamic analysis, this alloy forms the highest amount of fcc, suggesting that the fine layering observed may be related to in coating segregation between an fcc-phase and other, further alloy-phases. The tendency in alloy A7 to form a layered structure was largest when using 30 m/min clad speed.

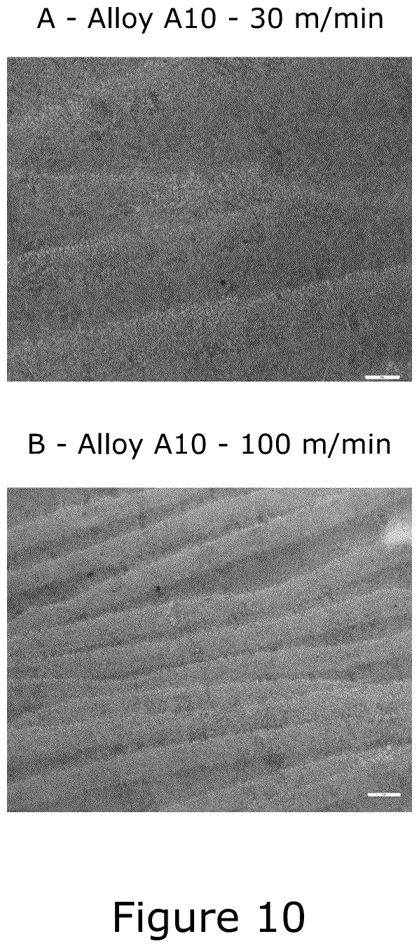

FIG. 10 shows the microstructure of the coatings for A10 in higher magnification for both 30 m/min and 100 m/min. Also, at the highest magnification it was not possible to resolve the microstructure by LOM.

Based on thermodynamics significant variations in fcc and bcc are expected in the investigated alloys. Nevertheless, the properties of the alloys are still within the desired target parameters. As the microstructure could not be resolved by LOM, SEM EBSD analysis of two alloys, one with large amount of austenite stabilizers as A7, one with large amount of ferrite stabilizers and for one alloy with target chemistry cladded at 100 m/min was performed.

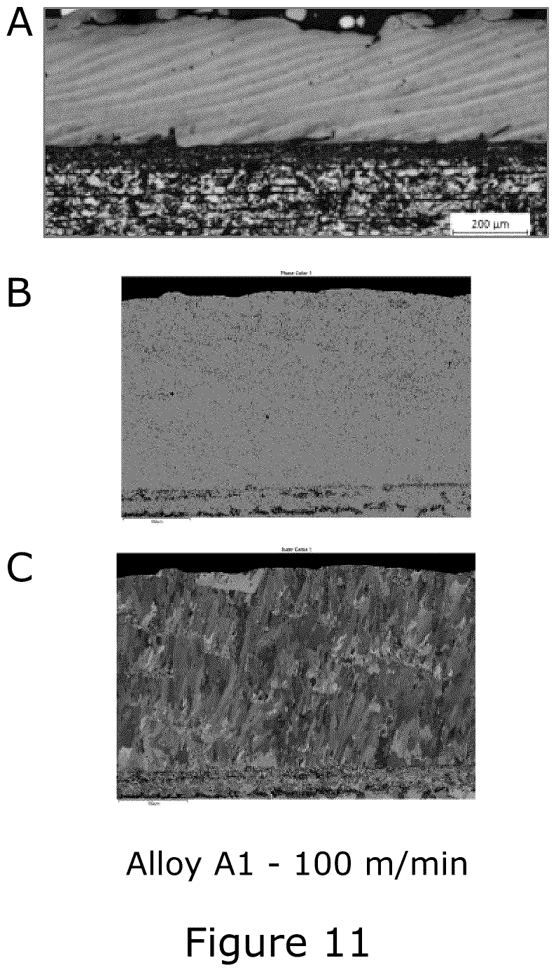

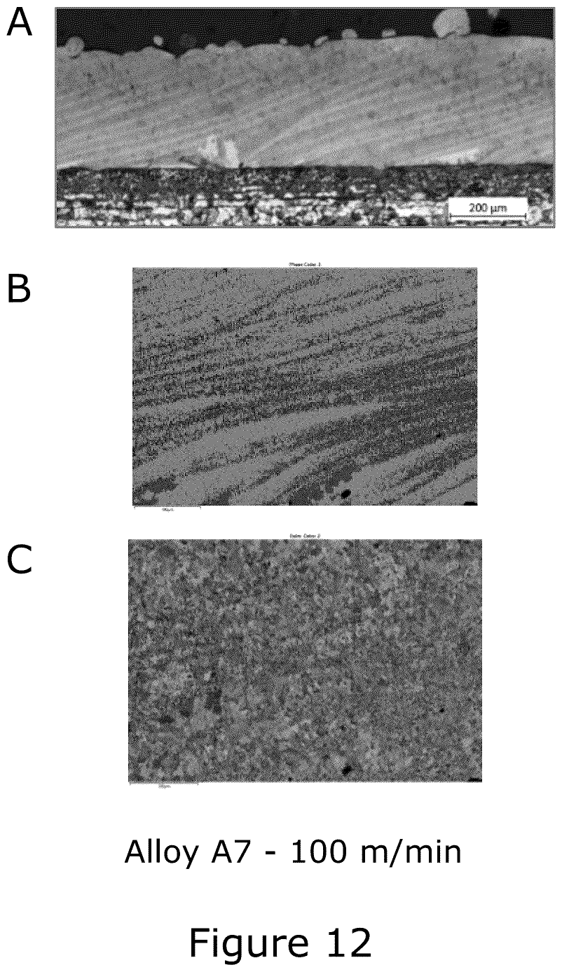

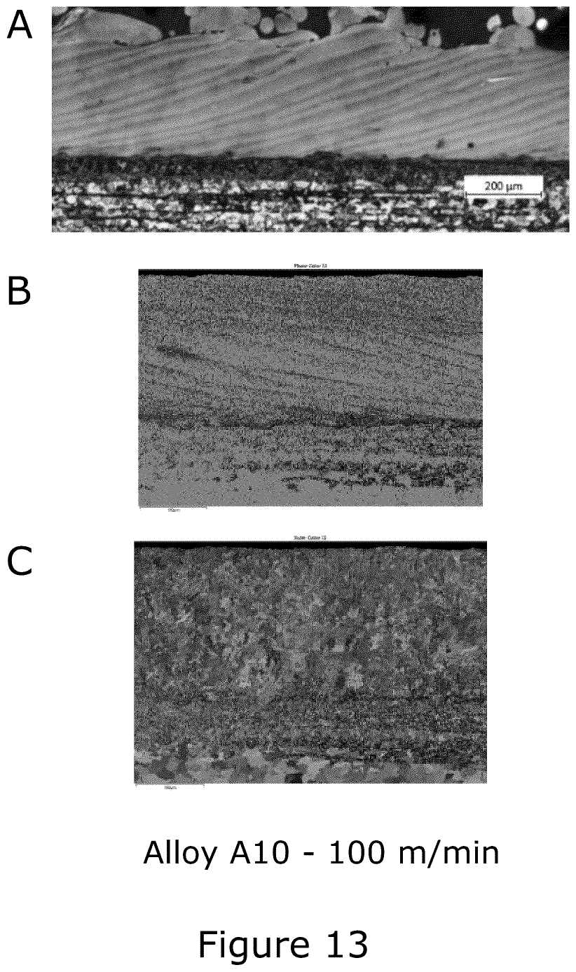

Overviews of the coating microstructure are illustrated in FIGS. 11 to 13 for alloys A1 (FIG. 11), A7 (FIG. 12) and A10 (FIG. 13), respectively. In FIGS. 11-13, Figures labelled A are overviews of the coating microstructure as observed by LOM, labels B are SEM EBSD maps, and labels C are Euler maps. The EBSD maps showed that the microstructure of A1 (FIGS. 11B and 11C) consisted of columnar primary grains of bcc phase, A7 consisted (FIGS. 12B and 12C) of more equiaxial primary grains of bcc and fcc present mainly in the overlap area and close to the substrate, whereas for alloy A10 (FIGS. 13B and 13C), the amount of bcc and fcc as well as the size of the primary grains was in between that of A1 and A7. For alloy A1, the SEM EBSD map (FIG. 11B) showed primarily a bcc structure with the black points being unresolved structure. The Euler map (FIG. 11C) showed elongated primary grains. For alloy A7, the SEM EBSD map (FIG. 12B) showed bcc structure (red), and fcc structure (blue), wherein the black points are unresolved structure. The Euler map (FIG. 12C) showed equiaxial primary grains. For alloy A10, the SEM EBSD map (FIG. 13B) showed bcc alignment (red), and fcc alignment (blue), wherein the black points are unresolved structure. The Euler map (FIG. 13C) showed equiaxial primary grains.

By looking at the microstructure of A1 and A7 in higher magnification it could be observed that the bcc structure in A1 showed a small number of defects indicated by the light grey pattern of the contrast band. This indicates that the microstructure consists of ferrite and eutectic structure. For A7 instead the contrast band showed areas with low number of defects (light grey in the contrast band map) consisting of ferrite and eutectic structure located in the central part of a track and areas with a larger number of defects (darker grey in the contrast band map) locating in the overlap between two tracks consisting most probably of martensite, retained austenite and eutectic structure.

The columnar shape the primary grains in A1 makes the alloys more sensitive to formation of hot cracks. The difference in size and geometry of the primary grains can explain why alloy A1 is more prone to form hot cracks than alloy A7.

### Corrosion Tests

All investigated alloys were tested for corrosion. The results are summarized in Table 12. For the criteria used to evaluate the samples see the reference pictures in FIG. 7 and Tables 4 to 6.

TABLE 12
Qualitative ranking of alloys tested in NSS for 7
days. The alloys were cladded using an HighNo
4.0 nozzle at 30 and 100 m/min:

| | NSS (7 days) | |
|---|---|---|
| Alloy Name | 30 m/min | 100 m/min |
| A1 | 9 | 7 |
| A2 | 9 | 9 |
| A3 | 8 | 8 |
| A4 | 9 | 9 |
| A5 | 5 | 5 |
| A6 | 7 | 7 |
| A7 | 9 | 0** |
| A8 | NA* | 0** |
| A10 | 9 | 9 |
| A11 | 9 | 9 |
| A12 | 8 | 8 |
| A20 | 7 | 8 |
| A21 | 7 | 6 |
| A22 | 5 | 6 |
| A23 | 9 | 9 |
| A24 | 9 | 8 |
| A28 | 9 | 9 |
| A26 | 8 | 8 |
| A27 | 8 | 9 |
| A29 | 9 | 9 |
| A30 | 5 | 5 |
| A31 | 9 | 0** |
| A32 | 9 | 0** |
| A33 | 8 | 7 |
| A34 | 9 | 9 |

*Not tested due to too much grinding
**Macrocracks

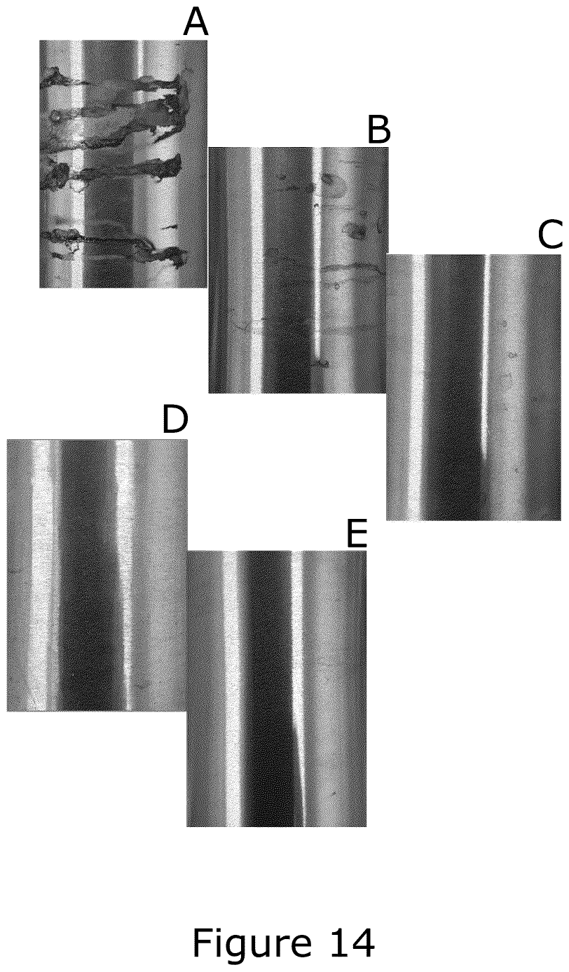

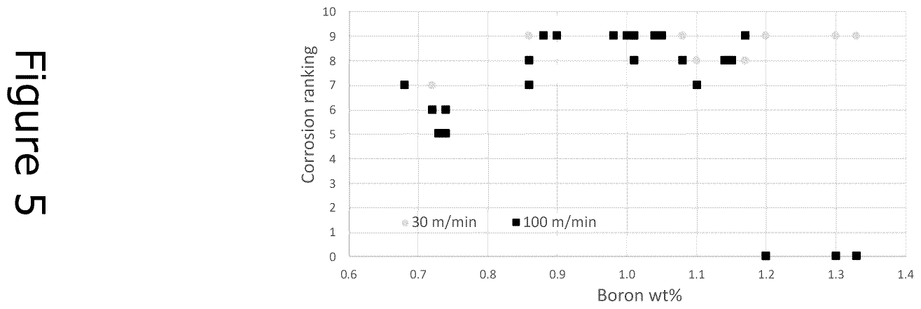

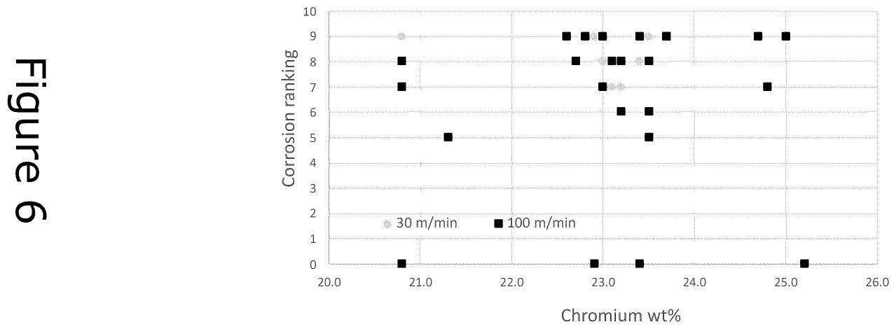

In FIG. 14, exemplary samples are shown for the respective gradings in increasing quality from A to E Rating of degree of corrosion after 7 days in NSS chamber. A is Rating=0, macrocracks in the coating; B is alloy A5 coated at 30 m/min, Rating=5, severe corrosion; C is alloy A21 coated at 30 m/min, Rating=6-7, moderate corrosion; D is alloy A26 coated at 30 m/min, Rating=8, slight corrosion; and E is alloy A31 coated at 30 m/min, Rating=9, very slight corrosion.

Some of the investigated alloys showed poor corrosion resistance in neutral salt spray. By plotting the corrosion rate was plotted vs respectively the boron (FIG. 15) and the chromium (FIG. 16) content it could be observed that the alloys with highest degree of corrosion showed the lowest boron content and the largest number of hot cracks, which indicates that hot cracks impact the corrosion resistance of the alloy. For the alloy ranked with 8 and 9, few corrosion spots could be detected on the surface. The spots appeared already after the first day and typically did not get larger after one week of testing.

### ThermoCalc—Results

The present inventors were in developing the present invention guided by considerations that depending on composition, fcc-phase might transform to martensite during cooling. High fraction of martensite will increase residual stress in the material and increase the risk for cracking. Likewise, as a guiding rule, the present inventors considered that too high levels of bcc-phase iron also increase the risk for hot-cracking.

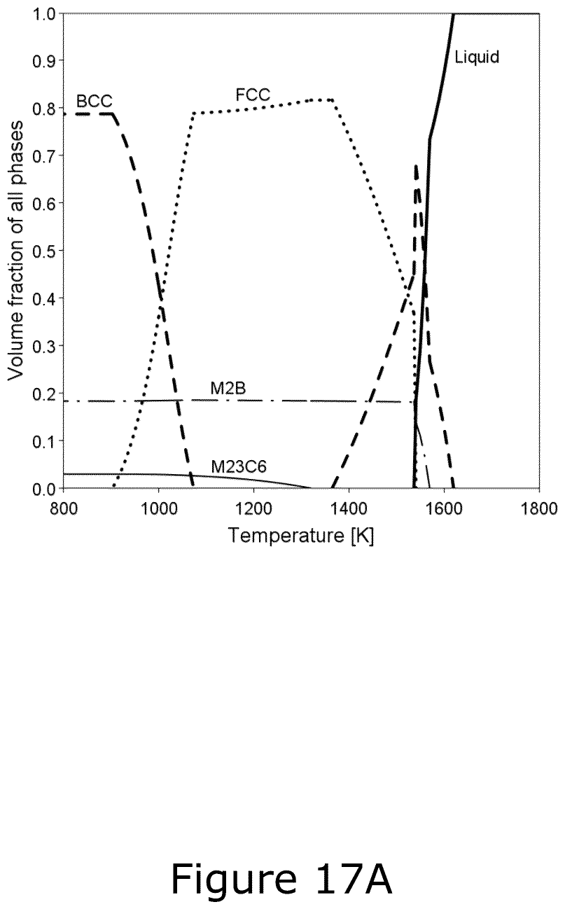

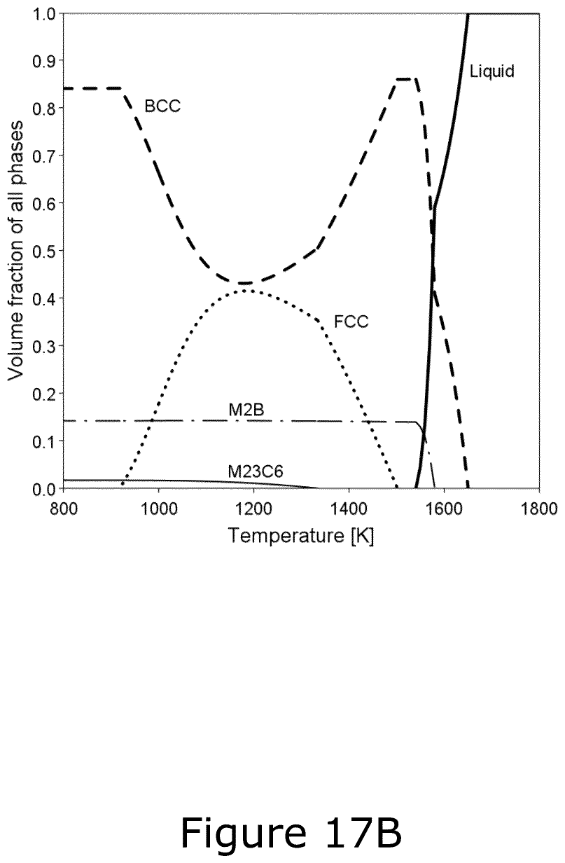

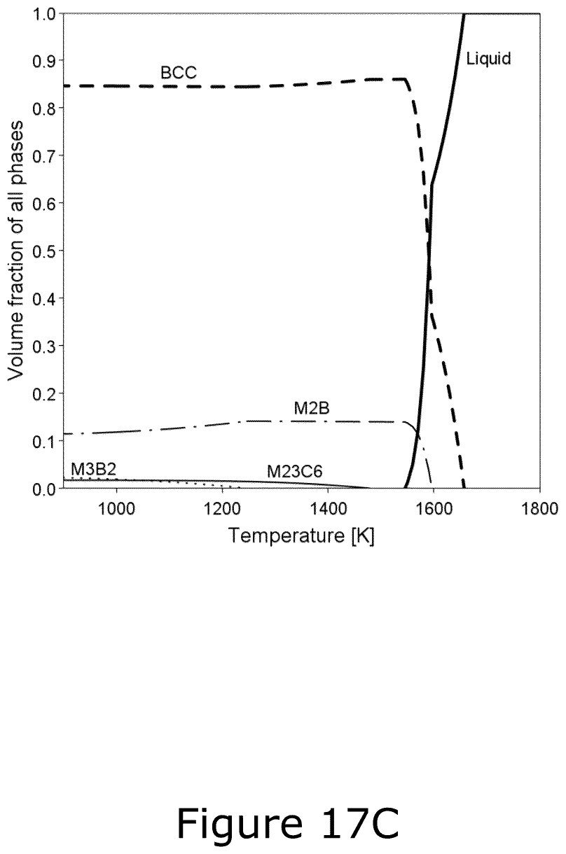

For examining the suitable chromium ranges based on the above guiding considerations, the present inventors examined three iron-chromium alloy compositions for their theoretically predicted phase-behavior. The calculations were performed with the software Thermo-Calc, using the commercially available database TCFE9, the compositions Fe-20.8Cr-2.8Ni-1.6Si-1.3B-0.4Mo-0.66Mn-0.16C, B) Fe-22.5Cr-3Ni-2Si-1B-0.4Mo-0.6Mn-0.09C (of the present invention), C) Fe-29Cr-3Ni-2Si-1B-2Mo-0.5-0.09C, cf. FIG. 17.

### A) Fe-20.8Cr-2.8Ni-1.6Si-1.3B-0.4Mo-0.66Mn-0.16C:

FIG. 17A shows an equilibrium calculation for the above composition (Fe-20.8Cr-2.8Ni-1.6Si-1.3B-0.4Mo-0.66Mn-0.16C) which subsequently was shown in the experiments (c.f. alloy A7) reported above to be unsuitable for high-speed laser cladding due to cracking issues.

Notably in the shown phase diagram is the absence a bcc-phase in the structure.

### B) Fe-22.5Cr-3Ni-2Si-1B-0.4Mo-0.6Mn-0.09C:

FIG. 17B shows an equilibrium calculation for the above composition (Fe-22.5Cr-3Ni-2Si-1B-0.4Mo-0.6Mn-0.09C,) which in the development work was proven suitable for high-speed laser cladding (c.f. alloy A10).

As can be seen, this material is not predicted to fully transform to fcc during cooling but shows a suitable balance between bcc and fcc phases. Maximum equilibrium fraction of the fcc-phase is approx. 0.45.

### C) Fe-29Cr-3Ni-2Si-1B-2Mo-0.5-0.09C:

FIG. 17C shows an equilibrium calculation for the above composition (Fe-29Cr-3Ni-2Si-1B-2Mo-0.5Mn-0.09C). As can be seen, no FCC is predicted for this composition and the matrix is completely ferritic (bcc). While high corrosion resistance is consequently achieved with high chromium and molybdenum, this, however, will increase fraction of the bcc-phase, which is too soft for the desired hardnesses of the presently intended uses. Consequently, the alloy was not tested in any experiment.

Overall, the presently disclosed alloys explore a desirable window of opportunity wherein the deteriorating influence of chromium (and molybdenum) on the necessary hardness for the intended uses are set off by the gained reduction in crack formation and the thereby resulting ability to form thinner coatings in a laser cladding procedure, while maintaining corrosion resistance and a usable hardness.

### Design Considerations and Conclusions

Final optimization trials were performed for the alloy chemistry in terms of cost and properties. The results are reported in Table 13.

In the trials, regards were taken to nickel being an expensive alloying element which stabilizes austenite. During cooling austenite transforms into martensite which contributes to the coating hardness. To verify if Ni additions contribute to the coating hardness an alloy with target chemistry and no pre-alloyed Ni (A25) was atomized and high-speed laser cladded. Hardness of the coating was not significantly affected which indicates that nickel additions are not critical for the hardness of the coating. The number of microcracks in the coating was larger compared to the alloys with target chemistry. The reason for this could be the formation of columnar ferritic grains during solidification.

In the trials, further regards were taken to, similarly to nickel, that carbon contributes to the coating hardness. Carbon stabilizes austenite which transforms into martensite during cooling and forms carbides. Due to the high solidification rate of the high-speed laser cladding process the impact of carbon on the coating hardness is not known. The alloys showed hardness close to that of the alloy with optimized chemistry. As both the alloys with and without carbon and with and without nickel showed similar hardness it can be assumed that borides and the fine grain structure are the main responsible for the coating hardness.

In the trials, further regards were taken to chromium being responsible for the corrosion resistance of the alloy. However, chromium stabilizes ferrite and a further increase of the target chromium content from 23 to 25 wt % could result in lower hardness of the coating. Therefore, an alloy with 25 wt % chromium and target chemistry for the remaining elements was investigated (A36). Hardness and microstructure of the coating were comparable to the alloy with target chemistry, and corrosion resistance was improved.

In the trials, further regards were taken to molybdenum being known from the literature to improve the pitting corrosion resistance, however as molybdenum is a ferrite stabilizer molybdenum addition could result in a lower the hardness of the coating. Therefore, an alloy with a target molybdenum content of 1.5 wt % was investigated (A40). Additions of molybdenum did not affect the coating hardness significantly.

TABLE 13
Coating properties of alloys with different chemistries, cladded at 30 and 100
m/min using the HighNo 4.0 nozzle showing optimized cladding properties.

| | | | | | | | NSS | |
|---|---|---|---|---|---|---|---|---|
| | HV0.2 | | Microcracks | | Micro- | | (7 days) | |
| Alloy | 30 m/min | 100 m/min | 30 m/min | 100 m/min | structure | | 30 m/min | 100 m/min |
| A39 | 433 | 437 | 1 | 1 | Even | Even | 9 | 8 |
| A36 | 431 | 436 | 1 | 1 | Even | Even | 10 | 9 |
| A40 | 452 | 460 | 1 | 1 | Even | Even | 9 | 9 |
| A43 | 439 | n.d. | 1 | 1 | Even | Even | 9-10 | 10 |

In conclusion, therefore, and while the herein detailed alloys according to the present invention, were all found suitable for high-speed cladding, alloys falling within the limits given by the below Table 14 were found particularly effective and compliant with the objectives of the present invention.

TABLE 14
Optimized alloy compositions without niobium (Nb)

| Chemistry | Set point | Min | Max |
|---|---|---|---|
| Fe | Bal | wt % | wt % |
| Cr | 23.5 | 22.00 | 25.00 |
| B | 1.00 | 0.90 | 1.10 |
| Mo | 0.50 | 0.30 | 1.80 |
| Ni | 3.00 | 2.50 | 3.50 |
| C | 0.10 | 0.00 | 0.15 |
| Mn | 0.50 | 0.30 | 0.70 |
| Si | 2.00 | 1.70 | 2.30 |

When niobium forms part of the alloys of the present invention, the carbon and boron content can be higher, as herein detailed above.

### CLOSING COMMENTS

Although the present invention has been described in detail for purpose of illustration, it is understood that such detail is solely for that purpose, and variations can be made therein by those skilled in the art in practicing the claimed subject matter, from a study of the drawings, the disclosure, and the appended claims.

The term “comprising” when used in the claims does not exclude other elements or steps. The indefinite article “a” or “an” as used in the claims does not exclude a plurality. A reference sign used in a claim shall not be construed as limiting the scope.

1-25. (canceled)

26. An iron-chromium based alloy consisting of, by weight of total weight of alloy:

| | | |
|---|---|---|
| Chromium (Cr) | : | 20.5 wt %-28.0 wt %, |
| Nickel (Ni) | : | up to 5.0 wt %, |
| Silicon (Si) | : | 0.5 wt %-2.5 wt %, |
| Boron (B) | : | 0.5 wt %-1.1 wt %, |
| Molybdenum (Mo) | : | 0.15 wt %-2.0 wt %, |
| Manganese (Mn) | : | 0.10 wt %-0.90 wt %, |
| Carbon (C) | : | 0.01 wt %-0.15 wt %, |
| Copper (Cu) | : | up to 0.2 wt %, |
| Cobalt (Co) | : | up to 1.0 wt %, |

the balance being iron (Fe) and unavoidable impurities including niobium not exceeding 0.3 wt %, and wherein the combined content of carbon (C) and boron (B) does not exceed 1.20 wt %.

27. The iron-chromium based alloy according to claim 26, wherein copper (Cu) is present up to 0.1 wt %.

28. The iron-chromium based alloy according to claim 26, wherein cobalt (Co) is present up to 0.2 wt %.

29. The iron-chromium based alloy according to claim 26, wherein chromium (Cr) is present from 21 wt % to 26 wt %.

30. The iron-chromium based alloy according to claim 26, wherein nickel (Ni) is present from 2.15 wt % to 3.85 wt %.

31. The iron-chromium based alloy according to claim 26, wherein silicon (Si) is present from 0.75 wt % to 2.45 wt %.

32. The iron-chromium based alloy according to claim 26, wherein boron (B) is present from 0.7 wt % to 1.1 wt %.

33. The iron-chromium based alloy according to claim 26, wherein molybdenum (Mo) is present up to 1.9 wt %.

34. The iron-chromium based alloy according to claim 26, wherein molybdenum (Mo) is present from 0.20 wt %.

35. The iron-chromium based alloy according to claim 26, wherein molybdenum (Mo) is present from 0.20 wt % to 1.3 wt %.

36. The iron-chromium based alloy according to claim 26, wherein manganese (Mn) is present from 0.35 wt % to 0.85 wt %.

37. The iron-chromium based alloy according to claim 26, wherein carbon is present from 0.01 wt % to 0.15 wt %.

38. The iron-chromium based alloy according to claim 26 in powder form.

39. The iron-chromium based alloy in powder form according to claim 38 formed by an atomization process.

40. The iron-chromium based alloy in powder form according to claim 39, wherein oxygen (O) as an unavoidable impurity introduced in the atomization process does not exceed 0.6 wt % by weight of total weight of alloyed powder.

41. The iron-chromium based alloy in powder form according to claim 38, wherein iron-chromium based alloy in powder form comprises at least 80% by weight of iron-chromium based alloy powder contained within a sieved fraction of the iron-chromium based alloy powder having a size distribution from 1 μm to 100 μm, as measured by sieving in accordance with ASTM B 214.

42. The iron-chromium based alloy in powder form according to claim 38, comprising at least 80% by weight of the iron-chromium based alloy powder having a size distribution from 2.5 μm to 100 μm as measured by sieving in accordance with ASTM B 214.

43. A method of using the powder according to claim 38, the method comprising coating a surface by means of a laser cladding method.

44. An iron-chromium based alloy formed in a laser cladding method from an iron-chromium based alloy according to claim 26.

45. A surface coating consisting of an iron-chromium based alloy according to claim 26.

46. A shaped object comprising a surface coating consisting of an iron-chromium based alloy according to claim 26.

47. A method for the production of a surface coating according to claim 45, having the steps:
an iron-chromium based alloy in powder form, configured for laser cladding;
carrying-out of a laser cladding process using said powder;
obtaining of said surface coating or of said object.

48. A composition for forming therefrom an iron-chromium based alloy according to claim 26, the composition consisting of by weight of total weight of the composition of:

| | | |
|---|---|---|
| Chromium (Cr) | : | 20.5 wt %-28.0 wt %, |
| Nickel (Ni) | : | up to 5.0 wt %, |
| Silicon (Si) | : | 0.5 wt %-2.5 wt %, |
| Boron (B) | : | 0.50 wt %-1.1 wt %, |
| Molybdenum (Mo) | : | 0.15 wt %-2.0 wt %, |
| Manganese (Mn) | : | 0.10 wt %-0.90 wt %, |
| Carbon (C) | : | 0.01 wt %-0.15 wt %, |
| Copper (Cu) | : | up to 0.2 wt %, |
| Cobalt (Co) | : | up to 1.0 wt %, |

the balance being iron (Fe) and unavoidable impurities including niobium (Nb) not exceeding 0.3 wt %, and wherein the combined content of carbon (C) and boron (B) does not exceed 1.20 wt %.
